(19) United States
(12) Patent Application Publication
(10) Pub. No.: US 2025/0214740 A1
(43) Pub. Date: Jul. 3, 2025

(54) LIQUID-TIGHT CONTAINER, PREFORM, METHOD FOR PRODUCING SAME, AND USES

(71) Applicant: SIG Services AG, Neuhausen am Rheinfall (CH)

(72) Inventors: Valentin Buchty, Ettlingen (DE); Stefan Pelzer, Herzogenrath (DE); Michael Schaaf, Herzogenrath (DE)

(21) Appl. No.: 18/850,047

(22) PCT Filed: Mar. 20, 2023
(86) PCT No.: PCT/EP2023/057090

§ 371 Date: Sep. 23, 2024

(30) Foreign Application Priority Data
Mar. 21, 2022 (DE) 10 2022 202 763.9

(51) Int. Cl. B65D 3/30; B31B 50/66; B31B 105/00; B31B 110/20; B31B 120/00; B65D 3/04; B65D 3/12

(52) U.S. Cl. CPC B65D 3/30; B31B 50/66; B65D 3/04; B65D 3/12; B31B 2105/0022; B31B 2110/20; B31B 2120/004

(57) ABSTRACT

The present invention relates to a liquid-tight container comprising a container wall which surrounds a container interior at least in part,
wherein: a jacket element and a first end element are connected to one another and each form a portion of the container wall;
wherein the jacket element
   delimits the container interior in a transverse direction extending from the inside to the outside in relation to the container interior, and
   comprises a rim portion having a first edge;
wherein the first end element
   delimits the container interior at a first end of the liquid-tight container in a longitudinal direction extending along the length of the container, and
   comprises a further edge which points in the longitudinal direction;
wherein the rim portion
a. is located at the first end of the container, and
b. encloses the further edge counter to the transverse direction from the outside to the inside in such a way that
i. the first edge of the jacket element points counter to the longitudinal direction, and
ii. the liquid-tight container comprises, at the first end in the transverse direction, a ply sequence comprising
A. a first ply of the jacket element,
B. a ply of the first end element, and
C. a further ply of the jacket element;
wherein the rim portion comprises, at least on a side pointing inwards counter to the transverse direction, a plurality of portions of a first type and a plurality of portions of a further type, which portions differ from one another in their thickness in the transverse direction.

The invention also relates to a precursor for producing the liquid-tight container, to a method for producing a liquid-tight container, to the use of a liquid-tight container, and to the use of an ultrasonic generator and/or an ultrasonic sonotrode.

The present invention relates to a liquid-tight container, comprising a container wall at least partially surrounding a container interior; wherein a jacket element and a first end element are connected to one another and each form a portion of the container wall; wherein the jacket element
delimits the container interior in a transverse direction extending from the inside to the outside in relation to the container interior, and
comprises a rim portion having a first edge;
   wherein the first end element
delimits the container interior at a first end of the liquid-tight container in a longitudinal direction extending along a length of the liquid-tight container, and
comprises a further edge which points in the longitudinal direction;
   wherein the rim portion
   a. is located at the first end of the liquid-tight container, and
   b. encloses the further edge counter to the transverse direction from the outside to the inside in such a way that
i. the first edge of the jacket element points counter to the longitudinal direction, and
ii. the liquid-tight container comprises, at the first end in the transverse direction, a ply sequence comprising
   A. a first ply of the jacket element,
   B. a ply of the first end element, and
   C. a further ply of the jacket element;
      wherein the rim portion comprises, at least on an inward-facing side counter to the transverse direction, a plurality of portions of a first type and a plurality of portions of a further type, which portions differ from one another in their thickness in the transverse direction.

The invention further relates to a precursor for producing the container, a method for producing a container, the use of a container, and to the use of an ultrasonic generator and/or an ultrasonic sonotrode.

For a long time, foodstuff, whether for human consumption or animal feed, has been preserved by storing it either in a can or in a glass jar sealed with a lid. Cans and jars have a number of disadvantages. For example, cans and jars have a considerable dead weight, which leads to increased energy expenditure during transport. In addition, the production of glass, tinplate or aluminum requires a high energy expenditure, even if the raw materials used come from recycling. In the case of jars, this is made worse by the increased cost of transport. The jars are usually prefabricated in a glassworks and then have to be transported to the plant that fills them with foodstuff, using considerable transport volumes. In addition, jars and cans can only be opened by using considerable force or with the aid of tools, making them rather awkward to open. In the case of cans, there is also a high risk of injury due to sharp edges that arise when opening them. When it comes to glass jars, it happens again and again that when filling or opening the filled jars, glass splinters get into the foodstuff, which in the worst case can lead to internal injuries when the foodstuff is consumed. In addition, both cans and jars must be labeled to identify and advertise their foodstuff contents. The jars and cans cannot easily be printed directly with information and advertising. In addition to the actual print, a substrate, a paper or a suitable film, as well as a fastening agent, an adhesive or a sealing agent, are necessary.

Other packaging systems are known from the prior art for storing foodstuff over a long period of time with as little impairment as possible. These are containers made from sheet-like composites, often referred to as laminates. Such sheet-like composites are often made up of a thermoplastic layer, a carrier layer, usually made of cardboard or paper, which gives the container dimensional stability, an adhesion promoter layer, a barrier layer, and a further plastics material layer. Since the carrier layer gives the container made from the laminate dimensional stability, these containers, in contrast to film pouches, can be seen as a further development of the aforementioned jars and cans.

One-piece, dimensionally stable foodstuff containers made of laminate are often substantially cuboidal in shape (see FIG. 20). These containers are made by folding and sealing a continuous piece of laminate. Here, the forming of the container bottom and of the container head often requires particularly sharp and also particularly many folds, some of which also intersect each other. Such accumulations of folds always tend to be detrimental to a particularly long shelf life of the foodstuff in the container. On the one hand, the barrier layer can be damaged at sharp fold edges or fold intersections. This is especially true in the case of a metal foil as barrier layer. If the barrier layer is damaged, the gas-tightness of the container suffers. Oxygen entering the container reduces its shelf life. On the other hand, while the carrier layer is foldable, it is also stiff enough to give the container dimensional stability. This often means that it is not possible to cleanly create an arbitrarily large number of sharp folds in a small area. Especially in the case of the container bottom, many folded plies of the laminate often lie on top of each other. Since the accumulated folds cannot be formed perfectly sharply and cleanly and, in addition, a targeted local application of the required amount of sealing agent is often not possible, it happens again and again that the laminate plies are not sealed together without gaps. This can lead to the formation of cavities between the layers. Germs can settle in such cavities and are very difficult to eliminate even by increased disinfection measures during container production. In addition, such cavities can form channels through the sequence of plies of the laminate, which enable the transport of gas and liquid through the sequence of plies and can thus significantly impair the tightness of the container.

These shelf life problems of one-piece containers can be countered by reducing the number of folds. For this purpose, the container can be constructed in multiple parts, i.e. with a separate lid and/or bottom. The lid or bottom is then made from a separate piece of laminate, which is connected, during the production of the container, to a piece of laminate that forms the side wall of the container. Such multi-part containers have significantly fewer sharp folds than single-part laminate containers. As a result, fewer leakage problems occur in the unloaded container and a longer shelf life can be achieved more reliably.

However, the tightness of these multi-part containers depends to a large extent on the connecting seam between the lid/bottom and the side wall of the container. As a result, such multi-part containers are more susceptible to loss of tightness due to mechanical influences, such as those that occur when a container falls down or when filled containers are stacked.

In general, it is an object of the present invention to at least partially overcome a disadvantage of the prior art.

A further object of the invention is to provide a preferably dimensionally stable liquid-tight foodstuff container formed from a separate end element that later forms the container bottom and a separate jacket part, in which both the end element and the jacket element are made from a laminate, the connecting seam between this end element and the jacket laminate being characterized by a particularly high liquid-tightness, in particular when the liquid-tight container stands with its container bottom in a water bath, for example on an irrigated conveyor belt, as is standardly used in the industrial production of foodstuff containers. Furthermore, it is an object of the invention to provide a preferably dimensionally stable liquid-tight foodstuff container made of laminate which has a tighter container bottom, in particular after a mechanical impact such as a fall. A further object of the invention is to provide a preferably dimensionally stable liquid-tight foodstuff container made of laminate which is characterized by improved mechanical stability, in particular against falling. A further object of the invention is to provide a method which is particularly designed for producing and preferably also filling one of the above-mentioned advantageous liquid-tight foodstuff containers. A further object of the invention is to provide a method for producing preferably dimensionally stable, liquid-tight foodstuff containers from separate end elements forming the container bottom and separate jacket parts, wherein a production rate of the method is as high as possible and a reject rate is as low as possible.

The independent claims make a contribution to achieving, at least partially, at least one, and preferably multiple, of the above objects. The dependent claims provide preferred embodiments that contribute to at least partially achieving at least one of the objects.

An embodiment 1 of a liquid-tight container, comprising a container wall at least partially surrounding a container interior, contributes to the fulfillment of at least one of the objects of the invention;
wherein a jacket element and a first end element are connected to one another and each form a portion of the container wall;
wherein the jacket element
   delimits the container interior in a transverse direction extending from the inside to the outside in relation to the container interior, and comprises a rim portion having a first edge;
wherein the first end element
   delimits the container interior at a first end of the liquid-tight container in a longitudinal direction extending along a length of the liquid-tight container, and
   comprises a further edge which points in the longitudinal direction;
wherein the rim portion
a. is located at the first end of the liquid-tight container, and
b. encloses the further edge counter to the transverse direction from the outside to the inside in such a way that
   i. the first edge of the jacket element points counter to the longitudinal direction, and
   ii. the liquid-tight container comprises, at the first end in the transverse direction, a ply sequence comprising
      A. a first ply of the jacket element,
      B. a ply of the first end element, and
      C. a further ply of the jacket element;
         wherein the rim portion includes, at least on an inward-facing side counter to the transverse direction, a plurality of portions of a first type and a plurality of portions of a further type; wherein the portions of the first type and the portions of the further type follow one another in a circumferential direction running along the further edge; wherein the first ply of the jacket element has a thickness in the transverse direction; wherein the thickness of the first ply is a mathematical function of a position along the circumferential direction; wherein the mathematical function has a plurality of local maxima and a plurality of local minima; wherein each portion of the first type includes exactly one of the local maxima and each portion of the further type includes exactly one of the local minima; wherein the thickness of the first ply in each entire portion of the first type is at least 0.7 times, preferably at least 0.8 times, more preferably at least 0.9 times, a value of the local maximum included by the respective portion of the first type; wherein the thickness of the first ply in each entire portion of the further type is at most 1.3 times, preferably at most 1.2 times, more preferably at most 1.1 times, a value of the local minimum included by the respective portion of the further type; wherein each portion of the first type has a first length in the circumferential direction; wherein each portion of the further type has a second length in the circumferential direction; wherein each second length is at least 10%, preferably at least 20%, more preferably at least 30%, more preferably at least 40%, more preferably at least 50%, more preferably at least 60%, more preferably at least 70%, more preferably at least 80%, more preferably at least 90%, more preferably at least 100%, more preferably at least 110%, more preferably at least 120%, more preferably at least 130%, more preferably at least 140%, most preferably at least 150%, of each first length.

An embodiment 1 of a liquid-tight container, comprising a container wall at least partially surrounding a container interior, contributes to the fulfillment of at least one of the objects of the invention;
wherein a jacket element and a first end element are connected to one another and each form a portion of the container wall;
wherein the jacket element
   delimits the container interior in a transverse direction extending from the inside to the outside in relation to the container interior, and
   comprises a rim portion having a first edge;
wherein the first end element
   delimits the container interior at a first end of the liquid-tight container in a longitudinal direction extending along a length of the liquid-tight container, and
   comprises a further edge which points in the longitudinal direction;
wherein the rim portion
a. is located at the first end of the liquid-tight container, and
b. encloses the further edge counter to the transverse direction from the outside to the inside in such a way that
   i. the first edge of the jacket element points counter to the longitudinal direction, and
   ii. the liquid-tight container comprises, at the first end in the transverse direction, a ply sequence comprising
      A. a first ply of the jacket element,
      B. a ply of the first end element, and
      C. a further ply of the jacket element;
         wherein the rim portion includes, at least on an inward-facing side opposite to the transverse direction, a plurality of portions of a first type and a plurality of portions of a further type; wherein the portions of the first type and the portions of the further type follow one another in a circumferential direction running along the further edge; wherein the first ply of the jacket element has a thickness in the transverse direction; wherein the thickness of the first ply is a mathematical function of a position along the circumferential direction; wherein the mathematical function has a plurality of local maxima and a plurality of local minima; wherein each first portion includes exactly one of the local maxima and each further portion includes exactly one of the local minima; wherein the thickness of the first ply in each entire first portion is at least 0.7 times, preferably at least 0.8 times, more preferably at least 0.9 times, a value of the local maximum included by the respective first portion; wherein the thickness of the first ply in each entire further portion is at most 1.3 times, preferably at most 1.2 times, more preferably at most 1.1 times, a value of the local minimum included by the respective further portion; wherein each portion of the first type has a first length in the circumferential direction; wherein each portion of the further type has a second length in the circumferential direction; wherein each second length is at least 10%, preferably at least 20%, more preferably at least 30%, more preferably at least 40%, more preferably at least 50%, more preferably at least 60%, more preferably at least 70%, more preferably at least 80%, more preferably at least 90%, more preferably at least 100%, more preferably at least 110%, more preferably at least 120%, more preferably at least 130%, more preferably at least 140%, most preferably at least 150%, of each first length.

Preferably, the first end of the liquid-tight container is a container bottom or a container head. Preferably, each direction selected from the longitudinal direction, the transverse direction, and the circumferential direction is perpendicular to the other two directions. Preferably, the value of each local maximum is greater than the value of each local minimum. Preferably, a smallest value of the thickness in each first portion is greater than a largest value of the thickness in each further portion. Preferably, the value of each local minimum is at most 90%, more preferably at most 80%, more preferably at most 70%, even more preferably at most 60%, most preferably at most 50%, of the value of each local maximum.

In a preferred embodiment of the liquid-tight container, every second length is greater than every first length, preferably by at least 10% of every first length, more preferably by at least 20% of every first length, more preferably by at least 30% of every first length, even more preferably by at least 40% of every first length, most preferably by at least 50% of every first length. This preferred embodiment is a 2nd embodiment of the container according to the invention, which is preferably based on the 1st embodiment of the invention.

In a preferred embodiment of the liquid-tight container the portions of the first type and the portions of the further type follow one another alternately, preferably directly, in the circumferential direction. This preferred embodiment is a 3rd embodiment of the container according to the invention, which is preferably based on the 1st or 2nd embodiment of the invention.

In a preferred embodiment of the liquid-tight container the value of each local minimum is 10 to 80%, preferably 10 to 70%, more preferably 10 to 60%, more preferably 10 to 50%, more preferably 20 to 50%, most preferably 30 to 50%, of the value of each local maximum. This preferred embodiment is a 4th embodiment of the container according to the invention, which is preferably based on one of the preceding embodiments of the invention.

In a preferred embodiment of the liquid-tight container the further edge along the circumferential direction forms a closed curve with a third length. This preferred embodiment is a 5th embodiment of the container according to the invention, which is preferably based on one of the preceding embodiments of the invention.

In a preferred embodiment of the liquid-tight container the rim portion encloses the further edge along at least 50%, preferably at least 60%, more preferably at least 70%, more preferably at least 80%, even more preferably at least 90%, most preferably 100%, of the third length. This preferred embodiment is a 6th embodiment of the container according to the invention, which is preferably based on the 5th embodiment of the invention.

In a preferred embodiment of the liquid-tight container the portions of the first type and the portions of the further type extend in total over at least 50%, preferably at least 60%, more preferably at least 70%, more preferably at least 80%, even more preferably at least 90%, most preferably 100%, of the third length. This preferred embodiment is a 7th embodiment of the container according to the invention, which is preferably based on the 5th or 6th embodiment of the invention.

In a preferred embodiment of the liquid-tight container the first end element has a height extending in the longitudinal direction at each point of the closed curve; wherein the rim portion protrudes beyond the further edge at each point of the closed curve such that the rim portion extends from the further edge to the first edge by an overhang length; wherein the overhang length is measured on a side of the rim portion facing away from the first end element; wherein the overhang length along at least 50%, preferably at least 60%, more preferably at least 70%, more preferably at least 80%, even more preferably at least 90%, most preferably 100%, of the third length is 30 to 100%, preferably 40 to 100%, more preferably 50 to 100%, even more preferably 60 to 100%, most preferably 70 to 100%, of the height. This preferred embodiment is an 8th embodiment of the container according to the invention, which is preferably based on one of the 5th to 7th embodiments of the invention.

In a preferred embodiment of the liquid-tight container the jacket element is at least partially, preferably completely, formed from a first sheet-like material. This preferred embodiment is a 9th embodiment of the container according to the invention, which is preferably based on one of the preceding embodiments of the invention.

In a preferred embodiment of the liquid-tight container the first sheet-like material comprises one selected from the group consisting of cardboard, paperboard, and paper, or a combination of at least two of these, preferably over its entire surface. Preferably, the first sheet-like material consists of this. This preferred embodiment is a 10th embodiment of the container according to the invention, which is preferably based on the 9th embodiment of the invention.

In a preferred embodiment of the liquid-tight container the first sheet-like material is a first sheet-like composite comprising a first layer sequence; wherein the first layer sequence comprises a first carrier layer, preferably over its entire surface. This preferred embodiment is an 11th embodiment of the container according to the invention, which is preferably based on the 9th or 10th embodiment of the invention.

In a preferred embodiment of the liquid-tight container the first carrier layer comprises one selected from the group consisting of cardboard, paperboard, and paper, or a combination of at least two of these. Preferably, the first carrier layer consists of this. This preferred embodiment is a 12th embodiment of the container according to the invention, which is preferably based on the 11th embodiment of the invention.

In a preferred embodiment of the liquid-tight container, the first carrier layer in the first layer sequence is overlaid with a first polymer inner layer on a side facing the container interior, preferably over its entire surface. This preferred embodiment is a 13th embodiment of the container according to the invention, which is preferably based on the 11th or 12th embodiment of the invention.

In a preferred embodiment of the liquid-tight container the first carrier layer in the first layer sequence is overlaid with a first polymer outer layer on a side facing away from the container interior, preferably over its entire surface. This preferred embodiment is a 14th embodiment of the container according to the invention, which is preferably based on one of the 11th to 13th embodiments of the invention.

In a preferred embodiment of the liquid-tight container the first layer sequence between the first carrier layer and the first polymer inner layer includes a first barrier layer, preferably over their entire surfaces. This preferred embodiment is a 15th embodiment of the container according to the invention, which is preferably based on the 13th or 14th embodiment of the invention.

In a preferred embodiment of the liquid-tight container the first carrier layer has at least one through-hole which is covered at least by the first polymer inner layer. Alternatively or in addition to the first polymer inner layer, the at least one through-hole in the first carrier layer is covered with the first barrier layer. This preferred embodiment is a 16th embodiment of the container according to the invention, which is preferably based on one of the 13th to 15th embodiments of the invention.

In a preferred embodiment of the liquid-tight container, the first end element is formed at least partially, preferably completely, from a second sheet-like material. This preferred embodiment is a 17th embodiment of the container according to the invention, which is preferably based on one of the preceding embodiments of the invention.

The second sheet-like material can differ in its structure from the first sheet-like material. Preferably, the second sheet-like material has the same structure as the first sheet-like material. In a further preferred embodiment, the second sheet-like material has a different structure from the first sheet-like material. Here, the second sheet-like material preferably comprises a material that the first sheet-like material does not comprise or vice versa. Alternatively or additionally, the second sheet-like material preferably has a different, preferably lower, basis weight than the first sheet-like material.

In a preferred embodiment of the liquid-tight container the second sheet-like material comprises one selected from the group consisting of cardboard, paperboard, and paper, or a combination of at least two of these, preferably over its entire surface. Preferably, the second sheet-like material consists of this. This preferred embodiment is an 18th embodiment of the container according to the invention, which is preferably based on the 17th embodiment of the invention.

In a preferred embodiment of the liquid-tight container the second sheet-like material is a second sheet-like composite comprising a second layer sequence; wherein the second layer sequence comprises a second carrier layer, preferably over its entire surface. A structure of the second carrier layer can differ from a structure of the first carrier layer. Preferably, the second carrier layer has the same structure as the first carrier layer. In a further preferred embodiment, the second carrier layer has a different structure from the first carrier layer. In this case, the second carrier layer preferably has a different, preferably lower, basis weight than the first carrier layer. This preferred embodiment is a 19th embodiment of the container according to the invention, which is preferably based on the 17th or 18th embodiment of the invention.

In a preferred embodiment of the liquid-tight container the second carrier layer comprises one selected from the group consisting of cardboard, paperboard, and paper, or a combination of at least two of these. Preferably, the second carrier layer consists of this. This preferred embodiment is a 20th embodiment of the container according to the invention, which is preferably based on the 19th embodiment of the invention.

In a preferred embodiment of the liquid-tight container the second carrier layer in the second layer sequence is overlaid with a second polymer inner layer on a side facing the container interior, preferably over its entire surface. This preferred embodiment is a 21st embodiment of the container according to the invention, which is preferably based on the 19th or 20th embodiment of the invention.

The second polymer inner layer can differ from the first polymer inner layer, for example in its material or its basis weight. Preferably, the second polymer inner layer has the same structure as the first polymer inner layer, i.e. in particular consists of the same material and has the same basis weight. In a further preferred embodiment, the second polymer inner layer has a different structure from the first polymer inner layer. Here the second polymer inner layer preferably consists of a different material than the first polymer inner layer, or the second polymer inner layer has a different basis weight than the first polymer inner layer, or both. Preferably, the second polymer inner layer has a lower basis weight than the first polymer inner layer.

In a preferred embodiment of the liquid-tight container the second carrier layer in the second layer sequence is overlaid with a second polymer outer layer on a side facing away from the container interior, preferably over its entire surface. This preferred embodiment is a 22nd embodiment of the container according to the invention, which is preferably based on one of the 19th to 21st embodiments of the invention.

The second polymer outer layer can differ from the first polymer outer layer, for example in its material or its basis weight. Preferably, the second polymer outer layer has the same structure as the first polymer outer layer, i.e. in particular consists of the same material and has the same basis weight. In a further preferred embodiment, the second polymer outer layer has a different structure from the first polymer outer layer. Here the second polymer outer layer preferably consists of a different material than the first polymer outer layer, or the second polymer inner layer has a different basis weight than the first polymer outer layer, or both. Preferably, the second polymer outer layer has a lower basis weight than the first polymer outer layer.

In a preferred embodiment of the liquid-tight container the second layer sequence between the second carrier layer and the second polymer inner layer comprises a second barrier layer, preferably over their entire surfaces. This preferred embodiment is a 23rd embodiment of the container according to the invention, which is preferably based on the 21st or 22nd embodiment of the invention.

The second barrier layer can differ from the first barrier layer, for example in its material or its basis weight. Preferably, the second barrier layer has the same structure as the first barrier layer, i.e. in particular consists of the same material and has the same basis weight.

In a preferred embodiment of the liquid-tight container, the second carrier layer has at least one through-hole which is covered at least with the second polymer inner layer. This preferred embodiment is a 24th embodiment of the container according to the invention, which is preferably based on one of the 19th to 23rd embodiments of the invention.

Alternatively or in addition to the second polymer inner layer, the at least one through-hole in the second carrier layer is covered with the second barrier layer. Preferably, the first end element closes the liquid-tight container at a first end, the first end preferably being a container head which is arranged opposite a container bottom along the length of the container.

In a preferred embodiment of the liquid-tight container the first end element is convex with respect to the container interior, i.e. curved away from the container interior. This preferred embodiment is a 25th embodiment of the liquid-tight container according to the invention, which is preferably based on one of the preceding embodiments of the invention.

In a preferred embodiment of the container, the first end element closes the liquid-tight container at the first end; wherein the jacket element delimits the container interior in a direction opposite to the longitudinal direction, and closes the liquid-tight container at a further end opposite the first end, relative to the length of the liquid-tight container. This preferred embodiment is a 26th embodiment of the container according to the invention, which is preferably based on one of the preceding embodiments of the invention.

In a preferred embodiment of the liquid-tight container a further end element forms a further portion of the container wall; wherein the further end element
delimits the container interior in a direction opposite to the longitudinal direction,
relative to the length of the liquid-tight container, is arranged at a further end of the liquid-tight container opposite the first end, and
is connected to the jacket element.

This preferred embodiment is a 27th embodiment of the container according to the invention, which is preferably based on one of the 1st to 25th embodiments of the invention.

In a preferred embodiment of the liquid-tight container, the first end member closes the liquid-tight container at the first end; wherein the further end element closes the liquid-tight container at the further end. This preferred embodiment is a 28th embodiment of the container according to the invention, which is preferably based on the 27th embodiment of the invention.

In a preferred embodiment of the liquid-tight container,
the first end is a container bottom and the further end is a container head, or
the first end is a container head and the further end is a container bottom.

This preferred embodiment is a 29th embodiment of the container according to the invention, which is preferably based on one of the 26th to 28th embodiments of the invention.

In a preferred embodiment of the liquid-tight container, the jacket element surrounds the further end element at least partially, preferably completely laterally. This preferred embodiment is a 30th embodiment of the container according to the invention, which is preferably based on one of the 27th to 29th embodiments of the invention.

In a preferred embodiment of the liquid-tight container the further end element is at least partially, preferably completely, formed from a third sheet-like material. This preferred embodiment is a 31st embodiment of the container according to the invention, which is preferably based on one of the 27th to 30th embodiments of the invention.

The third sheet-like material can differ in its structure from the first sheet-like material or the second sheet-like material or from both. Preferably, the second sheet-like material is of the same structure as the first sheet-like material or the second sheet-like material or both.

In a preferred embodiment of the liquid-tight container the third sheet-like material comprises one selected from the group consisting of cardboard, paperboard, and paper, or a combination of at least two of these, preferably over its entire surface. Preferably, the third sheet-like material consists of this. This preferred embodiment is a 32nd embodiment of the container according to the invention, which is preferably based on the 31st embodiment of the invention.

In a preferred embodiment of the liquid-tight container the third sheet-like material is a third sheet-like composite comprising a third layer sequence; wherein the third layer sequence comprises a third carrier layer. This preferred embodiment is a 33rd embodiment of the container according to the invention, which is preferably based on the 31st or 32nd embodiment of the invention.

A structure of the third carrier layer can differ from a structure of the first carrier layer or the second carrier layer or both. Preferably, the third carrier layer has the same structure as the first carrier layer or the second carrier layer or both.

In a preferred embodiment of the liquid-tight container the third carrier layer comprises one selected from the group consisting of cardboard, paperboard, and paper, or a combination of at least two of these. Preferably, the third carrier layer consists of this. This preferred embodiment is a 34th embodiment of the container according to the invention, which is preferably based on the 33rd embodiment of the invention.

In a preferred embodiment of the liquid-tight container the third carrier layer in the third layer sequence is overlaid with a third polymer inner layer on a side facing the container interior, preferably over its entire surface. This preferred embodiment is a 35th embodiment of the container according to the invention, which is preferably based on the 33rd or 34th embodiment of the invention.

The third polymer inner layer can differ, for example in its material or its basis weight, from the first polymer inner layer or the second polymer inner layer or from both. Preferably, the third polymer inner layer has the same structure as the first polymer inner layer or the second polymer inner layer or both, i.e. in particular consists of the same material and has the same basis weight.

In a preferred embodiment of the liquid-tight container the third carrier layer in the third layer sequence is overlaid with a third polymer outer layer on a side facing away from the container interior, preferably over its entire surface. This preferred embodiment is a 36th embodiment of the container according to the invention, which is preferably based on one of the 33rd to 35th embodiments of the invention.

The third polymer outer layer can differ, for example in its material or its basis weight, from the first polymer outer layer or the second polymer outer layer or from both. Preferably, the third polymer outer layer has the same structure as the first polymer outer layer or the second polymer outer layer or both, i.e. in particular consists of the same material and has the same basis weight.

In a preferred embodiment of the liquid-tight container the third layer sequence between the third carrier layer and the third polymer inner layer comprises a third barrier layer, preferably over their entire surfaces. This preferred embodiment is a 37th embodiment of the container according to the invention, which is preferably based on the 35th or 36th embodiment of the invention.

The third barrier layer can differ, for example in its material or its basis weight, from the first barrier layer or the second barrier layer or from both. Preferably, the third barrier layer has the same structure as the first barrier layer or the second barrier layer or both, i.e. in particular consists of the same material and has the same basis weight.

In a preferred embodiment of the liquid-tight container, the third carrier layer has at least one through-hole which is covered at least with the third polymer inner layer. Alternatively or in addition to the third polymer inner layer, the at least one through-hole in the third carrier layer is covered with the third barrier layer. Preferably the further end element closes the liquid-tight container at a further end, wherein the further end is preferably a container head which is arranged opposite a container bottom along the length of the liquid-tight container. This preferred embodiment is a 38th embodiment of the container according to the invention, which is preferably based on one of the 35th to 37th embodiments of the invention.

In a preferred embodiment of the liquid-tight container the further end element is concavely or convexly curved in relation to the container interior. This preferred embodiment is a 39th embodiment of the container according to the invention, which is preferably based on one of the 35th to 37th embodiments of the invention.

In a preferred embodiment of the container, the liquid-tight container, preferably the container wall, surrounds the container interior completely. In other words, the liquid-tight container is preferably closed. This preferred embodiment is a 39th embodiment of the container according to the invention, which is preferably based on one of the 1st to 38th embodiments of the invention.

In a preferred embodiment of the liquid-tight container, the container interior contains a liquid, preferably a foodstuff. This preferred embodiment is a 40th embodiment of the container according to the invention, which is preferably based on one of the 1st to 39th embodiments of the invention.

A contribution to the fulfillment of at least one of the objects of the invention is also made by an embodiment 1 of a precursor for producing the liquid-tight container according to the invention, preferably a liquid-tight container according to the invention according to one of the 1st to 40th embodiments, wherein the precursor comprises a container wall at least partially surrounding the container interior; wherein the jacket element and the first end element are connected to one another and each form a portion of the container wall; wherein the jacket element
delimits the container interior in the transverse direction, and
comprises the rim portion having the first edge;
   wherein the first end element
delimits the container interior at a first end of the precursor in the longitudinal direction, and
includes the further edge;
   wherein the rim portion is arranged at the first end of the precursor; wherein the first edge and the further edge point in the longitudinal direction; wherein the further edge forms a closed curve with a third length; wherein the first end element has a height extending in the longitudinal direction at each point of the closed curve; wherein the rim portion protrudes beyond the further edge at each point of the closed curve such that the rim portion extends from the further edge to the first edge by an overhang length; wherein the overhang length is measured on a side of the rim portion facing away from the first end element; wherein the overhang length along at least 50%, preferably at least 60%, more preferably at least 70%, more preferably at least 80%, even more preferably at least 90%, most preferably 100%, of the third length is 30 to 100%, preferably 40 to 100%, more preferably 50 to 100%, even more preferably 60 to 100%, most preferably 70 to 100%, of the height.

A contribution to the fulfillment of at least one of the objects of the invention is also made by an embodiment 1 of a precursor for producing the liquid-tight container according to the invention, preferably a liquid-tight container according to the invention according to one of the 1st to 40th embodiments, wherein the precursor comprises a container wall at least partially surrounding the container interior; wherein the jacket element and the first end element are connected to one another and each form a portion of the container wall; wherein the jacket element
delimits the container interior in the transverse direction, and
comprises the rim portion having the first edge;
   wherein the first end element
delimits the container interior at a first end of the precursor in the longitudinal direction, and
includes the further edge;
   wherein the rim portion is arranged at the first end of the precursor; wherein the first edge and the further edge point counter to the longitudinal direction; wherein the further edge forms a closed curve with a third length; wherein the first end element has a height extending in the longitudinal direction at each point of the closed curve; wherein the rim portion protrudes beyond the further edge at each point of the closed curve such that the rim portion extends from the further edge to the first edge by an overhang length; wherein the overhang length is measured on a side of the rim portion facing away from the first end element; wherein the overhang length along at least 50%, preferably at least 60%, more preferably at least 70%, more preferably at least 80%, even more preferably at least 90%, most preferably 100%, of the third length is 30 to 100%, preferably 40 to 100%, more preferably 50 to 100%, even more preferably 60 to 100%, most preferably 70 to 100%, of the height.

A contribution to the fulfillment of at least one of the objects of the invention is also made by an embodiment 1 of a method for producing a liquid-tight container, the method comprising as method steps
a. providing a precursor of the liquid-tight container, the precursor comprising a container wall that at least partially surrounds a container interior;
   wherein a jacket element and a first end element are connected to one another and each form a portion of the container wall;
   wherein the jacket element
      delimits the container interior in a transverse direction extending from the inside to the outside in relation to the container interior, and
      comprises a rim portion having a first edge;
   wherein the first end element
      delimits the container interior at a first end of the precursor in a longitudinal direction extending along a length of the precursor, and
      comprises a further edge;
   wherein the rim portion is arranged at the first end of the precursor;
   wherein the first edge and the further edge point in the longitudinal direction;
b. forming the rim portion by contacting it with a forming tool so that the rim portion encloses the further edge counter to the transverse direction from outside to inside so that
   i. the first edge of the jacket element points counter to the longitudinal direction, and
   ii. the precursor or the liquid-tight container obtained therefrom has at the first end in the transverse direction a ply sequence comprising
      A. a first ply of the jacket element,
      B. a ply of the first end element, and
      C. a further ply of the jacket element;
         characterized in that the forming tool carries out an oscillation with a frequency in a range from 15 to 50 kHz, preferably from 15 to 40 kHz, more preferably from 20 to 35 kHz, during the forming process. Preferably, the oscillation of the forming tool in method step b) results in a connection of the first end element to the jacket element with a material bond.

A contribution to the fulfillment of at least one of the objects of the invention is also made by an embodiment 1 of a method for producing a liquid-tight container, the method comprising as method steps
a. providing a precursor of the liquid-tight container, the precursor comprising a container wall that at least partially surrounds a container interior;
   wherein a jacket element and a first end element are connected to one another and each form a portion of the container wall;
   wherein the jacket element
      delimits the container interior in a transverse direction extending from the inside to the outside in relation to the container interior, and
      comprises a rim portion having a first edge;
   wherein the first end element
      delimits the container interior at a first end of the precursor in a longitudinal direction extending along a length of the precursor, and
      comprises a further edge;
   wherein the rim portion is arranged at the first end of the precursor;
   wherein the first edge and the further edge point counter to the longitudinal direction;
b. forming the rim portion by contacting it with a forming tool so that the rim portion encloses the further edge counter to the transverse direction from outside to inside so that
   i. the first edge of the jacket element points in the longitudinal direction, and
   ii. the precursor or the liquid-tight container obtained therefrom has at the first end in the transverse direction a ply sequence comprising
      A. a first ply of the jacket element,
      B. a ply of the first end element, and
      C. a further ply of the jacket element;
         characterized in that the forming tool carries out an oscillation with a frequency in a range from 15 to 50 kHz, preferably from 15 to 40 kHz, more preferably from 20 to 35 kHz, during the forming process. Preferably, the oscillation of the forming tool in method step b) results in a connection of the first end element to the jacket element with a material bond.

According to an embodiment of the invention, preferred elements from which the liquid-tight container according to the invention is obtained according to the method are formed as described for an embodiment of the liquid-tight container according to the invention.

Preferably, the transverse direction and the longitudinal direction are perpendicular to each other. Preferably, the oscillation has an amplitude in a range from 3 to 60 μm, preferably from 5 to 50 μm, more preferably from 10 to 45 μm. The oscillation preferably occurs in a direction which forms an angle of less than 30°, preferably less than 20°, more preferably less than 10°, even more preferably less than 5°, with the longitudinal direction and counter to this direction. Most preferably, the oscillation occurs in the longitudinal direction and counter to the longitudinal direction. A preferred forming tool is a sonotrode. The forming tool is preferably designed in one piece.

In a preferred embodiment of the method, the jacket element is formed at least partially, preferably completely, from a first sheet-like material, and preferably consists thereof. This preferred embodiment is a 2nd embodiment of the method according to the invention, which is preferably based on the 1st embodiment.

In a preferred embodiment of the method, the first sheet-like material comprises, preferably over its full surface, a material selected from the group consisting of cardboard, paperboard, and paper, or a combination of at least two of these. This preferred embodiment is a 3rd embodiment of the method according to the invention, which is preferably based on the 2nd embodiment.

In a preferred embodiment of the method, the first sheet-like material is a first sheet-like composite comprising a first layer sequence; wherein the first layer sequence comprises a first carrier layer, preferably over its entire surface. This preferred embodiment is a 4th embodiment of the method according to the invention, which is preferably based on the 2nd or 3rd embodiment.

In a preferred embodiment of the method, the first carrier layer comprises one material selected from the group consisting of cardboard, paperboard and paper, or a combination of at least two thereof, and preferably consists thereof. This preferred embodiment is a 5th embodiment of the method according to the invention, which is preferably based on the 4th embodiment.

In a preferred embodiment of the method, the first carrier layer in the first layer sequence is overlaid with a first polymer inner layer on a side facing the container interior, preferably over its entire surface. This preferred embodiment is a 6th embodiment of the method according to the invention, which is preferably based on the 4th or 5th embodiment.

In a preferred embodiment of the method, the first carrier layer in the first layer sequence is overlaid with a first polymer outer layer on a side facing away from the container interior, preferably over its entire surface. This preferred embodiment is a 7th embodiment of the method according to the invention, which is preferably based on one of the 4th to 6th embodiments.

In a preferred embodiment of the method, the first layer sequence between the first carrier layer and the first polymer inner layer includes a first barrier layer, preferably over their entire surfaces. This preferred embodiment is an 8th embodiment of the method according to the invention, which is preferably based on the 6th or 7th embodiments.

In a preferred embodiment of the method, the first carrier layer has at least one through-hole which is covered at least with the first polymer inner layer. Alternatively or in addition to the first polymer inner layer, the at least one through-hole in the first carrier layer is covered with the first barrier layer. This preferred embodiment is a 9th embodiment of the method according to the invention, which is preferably based on one of the 4th to 8th embodiments.

In a preferred embodiment of the method, the first end element is formed at least partially, preferably completely, from a second sheet-like material. The second sheet-like material can differ in its structure from the first sheet-like material. Preferably, the second sheet-like material has the same structure as the first sheet-like material. In a further preferred embodiment, the second sheet-like material has a different structure from the first sheet-like material. Here, the second sheet-like material preferably comprises a material that the first sheet-like material does not comprise or vice versa. Alternatively or additionally, the second sheet-like material preferably has a different, preferably lower, basis weight than the first sheet-like material. This preferred embodiment is a 10th embodiment of the method according to the invention, which is preferably based on one of the 1st to 9th embodiments.

In a preferred embodiment of the method, the second sheet-like material comprises, preferably consists of, one selected from the group consisting of cardboard, paperboard, and paper, or a combination of at least two of these, preferably over its entire surface. This preferred embodiment is an 11th embodiment of the method according to the invention, which is preferably based on the 10th embodiment.

In a preferred embodiment of the method, the second sheet-like material is a second sheet-like composite comprising a second layer sequence; wherein the second layer sequence comprises a second carrier layer, preferably over its entire surface. A structure of the second carrier layer can differ from a structure of the first carrier layer. Preferably, the second carrier layer has the same structure as the first carrier layer. In a further preferred embodiment, the second carrier layer has a different structure from the first carrier layer. In this case, the second carrier layer preferably has a different, preferably lower, basis weight than the first carrier layer. This preferred embodiment is a 12th embodiment of the method according to the invention, which is preferably based on the 10th or 11th embodiment.

In a preferred embodiment of the method, the second carrier layer comprises, preferably consists of, one selected from the group consisting of cardboard, paperboard, and paper, or a combination of at least two of these. This preferred embodiment is a 13th embodiment of the method according to the invention, which is preferably based on the 12th embodiment.

In a preferred embodiment of the method, the second carrier layer in the second layer sequence is overlaid with a second polymer inner layer on a side facing the container interior, preferably over its entire surface. The second polymer inner layer can differ from the first polymer inner layer, for example in its material or its basis weight. Preferably, the second polymer inner layer has the same structure as the first polymer inner layer, i.e. in particular consists of the same material and has the same basis weight. In a further preferred embodiment, the second polymer inner layer has a different structure from the first polymer inner layer. Here the second polymer inner layer preferably consists of a different material than the first polymer inner layer, or the second polymer inner layer has a different basis weight than the first polymer inner layer, or both. Preferably, the second polymer inner layer has a lower basis weight than the first polymer inner layer. This preferred embodiment is a 14th embodiment of the method according to the invention, which is preferably based on the 12th or 13th embodiment.

In a preferred embodiment of the method, the second carrier layer in the second layer sequence is overlaid with a second polymer outer layer on a side facing away from the container interior, preferably over its entire surface. The second polymer outer layer can differ from the first polymer outer layer, for example in its material or its basis weight. Preferably, the second polymer outer layer has the same structure as the first polymer outer layer, i.e. in particular consists of the same material and has the same basis weight. In a further preferred embodiment, the second polymer outer layer has a different structure from the first polymer outer layer. Here the second polymer outer layer preferably consists of a different material than the first polymer outer layer, or the second polymer inner layer has a different basis weight than the first polymer outer layer, or both. Preferably, the second polymer outer layer has a lower basis weight than the first polymer outer layer. This preferred embodiment is a 15th embodiment of the method according to the invention, which is preferably based on one of the 12th to 14th embodiments.

In a preferred embodiment of the method, the second layer sequence between the second carrier layer and the second polymer inner layer comprises a second barrier layer, preferably over their entire surfaces. The second barrier layer can differ from the first barrier layer, for example in its material or its basis weight. Preferably, the second barrier layer has the same structure as the first barrier layer, i.e. in particular consists of the same material and has the same basis weight. This preferred embodiment is a 16th embodiment of the method according to the invention, which is preferably based on the 14th or 15th embodiment.

In a preferred embodiment of the method, the second carrier layer has at least one through-hole which is covered at least with the second polymer inner layer. Alternatively or in addition to the second polymer inner layer, the at least one through-hole in the second carrier layer is covered with the second barrier layer. Preferably, the first end element closes the liquid-tight container at a first end, the first end preferably being a container head which is arranged opposite a container bottom along the length of the container. This preferred embodiment is a 17th embodiment of the method according to the invention, which is preferably based on one of the 12th to 16th embodiments.

In a preferred embodiment of the method, the forming of the rim portion is carried out by contacting the rim portion with a working surface of the forming tool; wherein the working surface has
a groove designed to receive the first edge, and
a plurality of recesses in the groove;
   wherein each of the recesses extends in the direction from a first longitudinal side of the groove to a further longitudinal side of the groove opposite the first longitudinal side. Preferably, each of the recesses extends from the first longitudinal side of the groove to the further longitudinal side of the groove. Alternatively or additionally preferably, the groove forms a closed curve. This preferred embodiment is an 18th embodiment of the method according to the invention, which is preferably based on one of the 11th to 17th embodiments.

In a preferred embodiment of the method, the groove has
a first depth in the recesses, and
a further depth outside the recesses
   wherein each further depth is 10 to 80%, preferably 10 to 70%, more preferably 10 to 60%, more preferably 10 to 50%, more preferably 20 to 50%, most preferably 30 to 50%, of each first depth. This preferred embodiment is a 19th embodiment of the method according to the invention, which is preferably based on the 18th embodiment.

In a preferred embodiment of the method, each of the recesses has a width in a direction of a length of the groove; wherein any two adjacent recesses of the plurality of recesses have a distance in the direction of the length of the groove; wherein each of the distances is at least 10%, preferably at least 20%, more preferably at least 30%, more preferably at least 40%, more preferably at least 50%, more preferably at least 60%, more preferably at least 70%, more preferably at least 80%, more preferably at least 90%, more preferably at least 100%, more preferably at least 110%, more preferably at least 120%, more preferably at least 130%, more preferably at least 140%, most preferably at least 150%, of each of the widths. This preferred embodiment is a 20th embodiment of the method according to the invention, which is preferably based on the 18th or 19th embodiment.

In a preferred embodiment of the method, each of the distances is greater than each of the widths, preferably by at least 10% of each of the widths, more preferably by at least 20% of each of the widths, more preferably by at least 30% of each of the widths, even more preferably by at least 40 of each of the widths, most preferably by at least 50% of each of the widths. This preferred embodiment is a 21st embodiment of the method according to the invention, which is preferably based on the 20th embodiment.

In a preferred embodiment of the method, each of the recesses has a longitudinal curvature in a direction of a length of the groove. This preferred embodiment is a 22nd embodiment of the method according to the invention, which is preferably based on one of the 18th to 21st embodiments.

In a preferred embodiment of the method, each of the longitudinal curvatures, preferably at any point along the longitudinal curvature, has a radius of curvature in a range from 1 to 5 mm, preferably from 1.2 to 3.0 mm, more preferably from 1.5 to 2.5 mm. This preferred embodiment is a 23rd embodiment of the method according to the invention, which is preferably based on the 22nd embodiment.

In a preferred embodiment of the method, each of the recesses has a transverse curvature in a direction transverse to a length of the groove. This preferred embodiment is a 24th embodiment of the method according to the invention, which is preferably based on one of the 18th to 23rd embodiments.

In a preferred embodiment of the method, each of the transverse curvatures has, at any point along the transverse curvature, a radius of curvature in a range from 1 to 5 mm, preferably from 1.2 to 3.0 mm, more preferably from 1.5 to 2.5 mm. This preferred embodiment is a 25th embodiment of the method according to the invention, which is preferably based on the 24th embodiment.

In a preferred embodiment of the method, a function that describes a dependence of a radius of curvature of each transverse curvature on a position along the transverse curvature, has a local maximum at a deepest point of the respective recess. This preferred embodiment is a 26th embodiment of the method according to the invention, which is preferably based on the 24th or 25th embodiment.

In a preferred embodiment of the method, the recesses of the plurality of recesses extend in total over at least 10%, preferably at least 20%, more preferably at least 30%, more preferably at least 40%, more preferably at least 50%, even more preferably at least 60%, most preferably 70%, of a length of the groove. This preferred embodiment is a 27th embodiment of the method according to the invention, which is preferably based on one of the 18th to 26th embodiments.

In a preferred embodiment of the method, in method step b. the liquid-tight container according to the invention, preferably the liquid-tight container according to the invention according to one of the 1st to 39th embodiments, is obtained from the container precursor. This preferred embodiment is a 28th embodiment of the method according to the invention, which is preferably based on one of the 1st to 27th embodiments.

In a preferred embodiment of the method, the further edge forms a closed curve with a third length; wherein the first end element in method step a. has a height extending in the longitudinal direction at each point of the closed curve; wherein the rim portion protrudes beyond the further edge at each point of the closed curve such that the rim portion extends from the further edge to the first edge by an overhang length; wherein the overhang length is measured on a side of the rim portion facing away from the first end element; wherein the overhang length along at least 50%, preferably at least 60%, more preferably at least 70%, more preferably at least 80%, even more preferably at least 90%, most preferably 100%, of the third length is 30 to 100%, preferably 40 to 100%, more preferably 50 to 100%, even more preferably 60 to 100%, most preferably 70 to 100%, of the height. This preferred embodiment is a 29th embodiment of the method according to the invention, which is preferably based on one of the 1st to 28th embodiments.

In a preferred embodiment of the method, the precursor provided in process step a. is a precursor according to the invention. This preferred embodiment is a 30th embodiment of the method according to the invention, which preferably relates to one of the 1st to 29th embodiments.

In a preferred embodiment of the method, the forming tool is set into oscillation before contacting the rim portion. This preferred embodiment is a 31st embodiment of the process according to the invention, which preferably relates to one of the 1st to 30th embodiments.

In a preferred embodiment of the method, the forming tool for forming in process step b. acts on the rim portion with a contact pressure in a range of 30 to 500 N, preferably 60 to 400 N, more preferably 90 to 300 N. Alternatively or additionally, it is preferred that the forming tool for forming in method step b. acts on the rim portion with a contact pressure in a range from 0.1 to 3.0 N per mm of a length of the rim portion along a circumferential direction, more preferably from 0.3 to 2.5 N per mm of the length of the rim portion along the circumferential direction, even more preferably from 0.4 to 2.0 N per mm of the length of the rim portion along the circumferential direction, most preferably from 0.5 to 1.8 N per mm of the length of the rim portion along the circumferential direction. Here, the circumferential direction runs along the further edge. Preferably, each direction selected from the longitudinal direction, the transverse direction, and the circumferential direction is perpendicular to the other two directions. This preferred embodiment is a 32nd embodiment of the method according to the invention, which is preferably based on one of the 1st to 31st embodiments.

In a preferred embodiment of the method, the first end element is convex in relation to the container interior, i.e. curved away from the container interior. This preferred embodiment is a 33rd embodiment of the method according to the invention, which is preferably based on one of the 1st to 32nd embodiments.

In a preferred embodiment of the method
the container in method step a. contains a liquid, preferably a foodstuff, or
after method step b. the container interior is filled with a liquid, preferably a foodstuff.

This preferred embodiment is a 34th embodiment of the method according to the invention, which is preferably based on one of the 1st to 33rd embodiments.

A contribution to the fulfillment of at least one of the objects of the invention is also made by the use of the liquid-tight container according to the invention, preferably the inventive liquid-tight container according to one of the 1st to 39th embodiments, for storing or transporting a liquid, preferably a foodstuff.

A contribution to the fulfillment of at least one of the objects of the invention is also made by a first embodiment of a use of a sheet-like composite for producing a liquid-tight container according to the invention, preferably the inventive liquid-tight container according to one of the 1st to 39th embodiments; wherein the jacket element or the first end element or both are formed at least partially, preferably completely, from the sheet-like composite.

In a preferred embodiment of the use, the sheet-like composite comprises a layer sequence; wherein the layer sequence comprises a carrier layer, preferably over its entire surface. This preferred embodiment is a 2nd embodiment of the use according to the invention, which is preferably based on the 1. embodiment.

In a preferred embodiment of the use, the carrier layer comprises one selected from the group consisting of cardboard, paperboard, and paper, or a combination of at least two thereof; preferably it consists thereof. This preferred embodiment is a 3rd embodiment of the use according to the invention, which is preferably based on the 2nd embodiment.

In a preferred embodiment of the use, the carrier layer in the layer sequence is overlaid on an outer side, preferably over its entire surface, with a polymer inner layer. This preferred embodiment is a 4th embodiment of the use according to the invention, which is preferably based on the 2nd or 3rd embodiment.

In a preferred embodiment of the use, the carrier layer in the layer sequence is overlaid on an outer side, preferably over its entire surface, with a polymer outer layer. This preferred embodiment is a 5th embodiment of the use according to the invention, which is preferably based on one of the 2nd to 4th embodiments.

In a preferred embodiment of the use, the layer sequence comprises a barrier layer between the carrier layer and the polymer inner layer, preferably over their entire surfaces. This preferred embodiment is a 6th embodiment of the use according to the invention, which is preferably based on the 4th or 5th embodiment.

A contribution to the fulfillment of at least one of the objects according to the invention is also made by the use of
a) an ultrasonic generator to excite the oscillation, or
b) an ultrasonic sonotrode as the forming tool,
c) or a) and b)
   each in the method according to the invention for producing a liquid-tight container, preferably in the inventive method according to one of the 1st to 34th embodiments.

Features which are described as preferred in a category according to the invention, for example according to the liquid-tight container according to the invention, are also preferred in an embodiment of the further categories according to the invention, for example an embodiment of the method according to the invention for producing a liquid-tight container, or the uses of a sheet-like composite, or of an ultrasonic sensor and/or an ultrasonic sonotrode. Furthermore, the features described below are preferred in connection with each category.

### Container

The container according to the invention is preferably a foodstuff container. Preferably, the interior of a container according to the invention contains a foodstuff. The container wall is preferably watertight. Furthermore, the container is preferably dimensionally stable. This means that the container wall substantially retains its shape when filled. A plurality of different shapes of the container wall are conceivable here.

Preferably, the container wall, at least in portions, preferably at least in the region of the container head or the container bottom or both, even more preferably substantially completely, substantially has the shape of a prism or a cylinder. A preferred prism here is a straight prism or an oblique prism. Alternatively or additionally preferably, the prism is regular or non-regular. The formulation “substantially the shape” here means that the container wall or the corresponding portion thereof does not have to have the shape of a geometrically exact prism or a geometrically exact cylinder. For example, the polygon that forms a base of the prism may have rounded corners, so that the prism has rounded edges. In this case, a container wall that has such a shape also substantially has the shape of a prism. Another preferred container has a container wall which, at least in portions, preferably at least in the region of the container head or the container bottom or both, even more preferably substantially completely, has the shape of a geometric body which can be obtained by parallel displacement of a flat bottom surface with a rounded shape. A preferred flat bottom with a rounded shape is kidney-shaped.

The container wall can be made of different materials. It is conceivable that in addition to sheet-like materials, in particular sheet-like composites, other materials are also used, for example one or more molded parts made of a plastics material. Such molded parts can be used in particular in the container head or container bottom. However, it is preferred here that the container wall to an extent of at least 50%, more preferably at least 60%, more preferably at least 70%, particularly preferably at least 80%, and furthermore preferably at least 90%, of its surface facing away from the container interior (outer surface) consists of one or more sheet-like materials, in particular sheet-like composites. Alternatively or additionally, at least 50%, more preferably at least 60%, more preferably at least 70%, particularly preferably at least 80%, and further preferably at least 90%, of the outer surface of the container wall are formed by the jacket element and the first and/or further end element.

The container according to the invention is preferably a closed container. The container can have a device for emptying the contents (opening aid). This aid can, for example, be formed from a polymer or a mixture of polymers and attached to the outside of the container. It is also conceivable that this device is integrated in the container by “direct injection molding”.

### Jacket Element

The jacket element forms a region of the container wall of the container according to the invention. This region is preferably a lateral region of the container wall, i.e. a region of the container wall which is lateral in relation to the length of the container. Accordingly, the jacket element laterally limits the container interior. The region of the container wall formed by the jacket element preferably has the shape of a lateral surface of a prism or of a cylinder. A preferred prism here is a straight prism or an oblique prism. Alternatively or additionally preferably, the prism is regular or non-regular. The jacket element includes a first sheet-like material; preferably the jacket element consists thereof. Here, the first sheet-like material preferably has a first edge and an oppositely arranged further edge, wherein the first edge and the further edge are connected to one another, preferably sealed to one another. A preferred jacket element is formed in one piece.

### End Element

The first end element is preferably a lid element or a bottom element, particularly preferably a bottom element. If the first end element is a lid element and the container comprises a further end element, the further end element is preferably a bottom element. If the first end element is a bottom element and the container comprises a further end element, the further end element is preferably a lid element. If the container wall has the shape of a prism or cylinder, the first end element and, if present, preferably also the further end element each form an end face of the prism or cylinder. The first end element limits the container interior in a first direction along the length of the container. If present, the further end element limits the container interior in a direction opposite to the first direction. In other words, the first end element and the further end element axially limit the container interior. The portion of the container wall formed by the first end element preferably has the shape of a polygonal area or a circular area. Alternatively or additionally preferably, the portion of the container wall formed by the further end element has the shape of a polygonal area or a circular area. A preferred polygon area is an area of a regular polygon or of a non-regular polygon.

A preferred first end element is formed in one piece or has no connection point, in particular no seam, or both. Alternatively or additionally preferably, the further end element is formed in one piece or has no connection point, in particular no seam, or both.

### Sheet-Like Material/Sheet-Like Composite

In the following, “the sheet-like material” refers to each of the first to third sheet-like materials. Similarly, the “sheet-like composite” refers to each of the first to third sheet-like composites. All flat, in particular sheet-like, materials, in particular laminates, which are conceivable within the scope of the invention and which appear to the person skilled in the art to be suitable for use in accordance with the invention for the manufacture of dimensionally stable foodstuff containers can be considered as a sheet-like material. The sheet-like material preferably comprises a carrier layer. In a preferred embodiment of the invention, the carrier layer is overlaid, preferably printed, on one side with a color application. In a further preferred embodiment, the sheet-like material is present as a sheet-like composite. Sheet-like composites for producing foodstuff containers are also called laminates. Such sheet-like composites have a sequence of layers overlaid on one another in a sheet-like manner. The sheet-like composites are often made up of a thermoplastic polymer layer, which is referred to herein as the polymer outer layer, a carrier layer usually consisting of cardboard or paper, which gives the container its dimensional stability, an optional thermoplastic polymer layer, which is referred to herein as the polymer intermediate layer and/or an optional adhesion promoter layer, a barrier layer and a further thermoplastic polymer layer, which is referred to herein as the polymer inner layer. The layers of the sheet-like composite that form the layer sequence are preferably connected to one another in a sheet-like manner. Two layers are connected to one another if their adhesion to each other exceeds van der Waals forces of attraction. Layers connected to one another are preferably one selected from the group consisting of layers sealed to one another, glued to one another, and pressed to one another, or a combination of at least two thereof. Unless otherwise stated, the layers in a layer sequence can follow one another indirectly, i.e. with one or at least two intermediate layers, or directly, i.e. without an intermediate layer. This is the case in particular with the formulation in which one layer overlays another layer. A formulation in which a layer sequence includes enumerated layers means that at least the specified layers are present in the specified sequence. This formulation does not necessarily mean that these layers follow one another directly. A formulation in which two layers are adjacent to each other means that these two layers follow one another directly and thus without an intermediate layer. However, this formulation says nothing about whether the two layers are connected to one another or not. Rather, these two layers can be in contact with each other. Preferably, however, these two layers are connected to each other, preferably in a sheet-like manner. The first to third sheet-like materials mentioned in the context of the invention, in particular the first to third sheet-like composites, can have the same or different structures. In a preferred embodiment, the second and third sheet-like materials have the same structure. In a further preferred embodiment, the first and second sheet-like materials have the same structure. In a further preferred embodiment, the first and third sheet-like materials have the same structure. In a particularly preferred embodiment, the first to third sheet-like materials have the same structure.

### Polymer Layers

In the following, the term “polymer layer” refers in particular to the polymer inner layer, the polymer intermediate layer, and the polymer outer layer. The polymer layers are each based on a polymer or a polymer mixture. A preferred polymer is a thermoplastic polymer, more preferably a polyolefin. The polymer layers are preferably incorporated into or applied to the sheet-like composite material in an extrusion process, preferably by layer extrusion. In addition to the polymer or polymer mixture, each polymer layer can include additional components. The other components of the polymer layers are preferably components that do not adversely affect the behavior of the polymer melt when applied as a layer. The other components can be, for example, inorganic compounds such as metal salts or other plastics materials such as other thermoplastics. Suitable polymers for the polymer layers are particularly those that are easy to process due to good extrusion behavior. Suitable polymers are those obtained by chain polymerization, in particular polyolefins, wherein cyclic olefin copolymers (COC), polycyclic olefin copolymers (POC), in particular polyethylene and polypropylene, are particularly preferred, and polyethylene is very particularly preferred. Preferred polyethylenes include HDPE (high density polyethylene), MDPE (medium density polyethylene), LDPE (low density polyethylene), LLDPE (linear low density polyethylene) and VLDPE (very low density polyethylene), as well as mixtures of at least two of these. Suitable polymer layers have a melt flow rate (MFR) in a range from 1 to 25 g/10 min, preferably in a range from 2 to 20 g/10 min and particularly preferably in a range from 2.5 to 15 g/10 min, and a density in a range from 0.890 g/cm³ to 0.980 g/cm³, preferably in a range from 0.895 g/cm³ to 0.975 g/cm³, and more preferably in a range from 0.900 g/cm³ to 0.970 g/cm³. The polymer layers preferably have at least one melting temperature in a range from 80 to 155° C., preferably in a range from 90 to 145° C., and particularly preferably in a range from 95 to 135° C.

### Polymer Inner Layer

The polymer inner layer is based on at least one thermoplastic polymer, wherein the polymer inner layer can include a particulate inorganic solid. However, it is preferred that the polymer inner layer comprises one or more thermoplastic polymers in a proportion of at least 70 wt. %, preferably at least 80 wt. % and particularly preferably at least 95 wt. %, based in each case on the total weight of the polymer inner layer. Preferably, the polymer or the polymer mixture of the polymer inner layer has a density (according to ISO 1183-1:2004) in a range from 0.900 to 0.980 g/cm³, particularly preferably in a range from 0.900 to 0.960 g/cm³, and most preferably in a range from 0.900 to 0.940 g/cm³. Preferably, the polymer is a polyolefin. The polymer inner layer preferably comprises a polyethylene or a polypropylene or both. A particularly preferred polyethylene here is LDPE.

### Polymer Outer Layer

The polymer outer layer preferably comprises a polyethylene or a polypropylene or both. LDPE and HDPE, as well as mixtures of these, are preferred as polyethylene. A preferred polymer outer layer comprises an LDPE to in a proportion of at least 50 wt. %, preferably at least 60 wt. %, more preferably at least 70 wt. %, even more preferably at least 80 wt. %, most preferably at least 90 wt. %, based in each case on the weight of the polymer outer layer.

### Polymer Intermediate Layer

The polymer intermediate layer preferably comprises a polyethylene or a polypropylene or both. A particularly preferred polyethylene here is LDPE. Preferably, the polymer intermediate layer comprises the polyethylene or the polypropylene or both together in a proportion of at least 20 wt. %, more preferably at least 30 wt. %, more preferably at least 40 wt. %, more preferably at least 50 wt. %, more preferably at least 60 wt. %, more preferably at least 70 wt. %, more preferably at least 80 wt. %, most preferably at least 90 wt. %, based in each case on the total weight of the polymer intermediate layer.

### Barrier Layer

Any material known to be suitable for this purpose to a person skilled in the art and which has a sufficient barrier effect, in particular against oxygen, can be used as a barrier layer. For this purpose, the barrier layer preferably comprises an oxygen permeation rate of less than 50 cm³/(m²·day atm), preferably less than 40 cm³/(m²·day atm), more preferably less than 30 cm³/(m²·day atm), more preferably less than 20 cm³/(m²·day atm), more preferably less than 10 cm³/(m²·day atm), even more preferably less than 3 cm³/(m²·day atm), most preferably not more than 1 cm³/(m²·day·atm). The barrier layer preferably also has a barrier effect against water vapor. Accordingly, the barrier layer is preferably an oxygen barrier layer and further preferably additionally a water vapor barrier layer. In addition, the barrier layer preferably has a barrier effect against visible light; i.e., it is also a light barrier layer.

The barrier layer is preferably selected from
a. a plastics material barrier layer;
b. a metal layer;
c. an oxide layer; or
d. a combination of at least two of a. to c.

If the barrier layer according to alternative a. is a plastics material barrier layer, it preferably comprises at least 70 wt. %, particularly preferably at least 80 wt. % and most preferably at least 95 wt. %, of at least one plastics material which is known to the person skilled in the art for this purpose, in particular because of aroma or gas barrier properties suitable for packaging containers. As plastics materials, in particular thermoplastics, N or O-bearing plastics can be considered here, both by themselves and in mixtures of two or more. According to the invention, it can prove advantageous if the plastics material barrier layer has a melting temperature in a range of more than 155 to 300° C., preferably in a range of 160 to 280° C., and particularly preferably in a range of 170 to 270° C.

More preferably, the plastics material barrier layer has a basis weight in a range of 2 to 120 g/m², preferably in a range of 3 to 60 g/m², particularly preferably in a range of 4 to 40 g/m² and further preferably from 6 to 30 g/m². Furthermore, the plastics material barrier layer is preferably obtainable from melts, for example by extrusion, in particular layer extrusion. Furthermore, the plastics material barrier layer can also preferably be incorporated into the sheet-like composite by lamination. Here, it is preferable for a film to be incorporated into the sheet-like composite. According to another embodiment, plastics material barrier layers can also be selected which are obtainable by deposition from a solution or dispersion of plastics materials.

Suitable polymers are preferably those which have a molecular weight with a weight average, determined by gel permeation chromatography (GPC) using light scattering, in a range from 3·10³ to 1·10⁷ g/mol, preferably in a range from 5·10³ to 1·10⁶ g/mol and particularly preferably in a range from 6·10³ to 1·10⁵ g/mol. Suitable polymers include polyamide (PA) or polyethylene vinyl alcohol (EVOH) or a mixture thereof. Among the polyamides, all PAs that appear suitable to the person skilled in the art for use according to the invention are suitable.

All EVOHs that appear suitable to the person skilled in the art for use according to the invention can be considered as EVOH. Examples of this are commercially available under the trade names EVAL™ of EVAL Europe NV, Belgium, in a variety of different versions, for example EVAL™ F104B or EVAL™ LR171B. Preferred EVOHs have at least one, two, a plurality of, or all of the following properties:
an ethylene content in a range from 20 to 60 mol %, preferably from 25 to 45 mol %;
a density in a range of 1.0 to 1.4 g/cm³, preferably from 1.1 to 1.3 g/cm³;
a melting point in a range from more than 155 to 235° C., preferably from 165 to 225° C.;
an MFR value (210° C./2.16 kg, if T_{S(EVOH)}<210° C.; 230° C./2.16 kg, if 210° C.<T_{S(EVOH)}<230° C.) in a range from 1 to 25 g/10 min, preferably from 2 to 20 g/10 min;
an oxygen permeation rate in a range from 0.05 to 3.2 cm³·20 μm/(m²·day atm), preferably in a range from 0.1 to 1 cm³·20 μm/(m²·day·atm).

Preferably, at least one polymer layer, more preferably the polymer inner layer, or preferably all polymer layers have a melting temperature below the melting temperature of the barrier layer. This is especially true if the barrier layer consists of polymer. In this case, the melting temperatures of the at least one, in particular the polymer inner layer, and the melting temperature of the barrier layer preferably differ by at least 1 K, particularly preferably by at least 10 K, even more preferably by at least 50 K, further preferably at least 100 K. The temperature difference should preferably be selected to be only so high that it does not cause melting of the barrier layer, in particular not to melting of the plastics material barrier layer, during folding.

According to alternative b., the barrier layer is a metal layer. In principle, all layers comprising metals that are known to those skilled in the art and can provide a high level of light and oxygen impermeability are suitable as metal layers. According to a preferred embodiment, the metal layer can be a foil or a deposited layer, e.g. after physical vapor deposition. The metal layer is preferably a continuous layer. According to a further preferred embodiment, the metal layer has a thickness in a range from 3 to 20 μm, preferably in a range from 3.5 to 12 μm, and particularly preferably in a range from 4 to 10 μm.

Preferred metals are aluminum, iron, or copper. As an iron layer, a steel layer, e.g. in the form of a foil, can be preferred. Furthermore, the metal layer is preferably a layer with aluminum. The aluminum layer can expediently consist of an aluminum alloy, for example AlFeMn, AlFe1.5Mn, AlFeSi, or AlFeSiMn. The purity is usually 97.5% and higher, preferably 98.5% and higher, based in each case on the entire aluminum layer. In a special design, the metal layer consists of an aluminum foil. Suitable aluminum foils have an extensibility of more than 1%, preferably more than 1.3%, and particularly preferably more than 1.5%, and a tensile strength of more than 30 N/mm², preferably more than 40 N/mm², and particularly preferably more than 50 N/mm². Suitable aluminum foils show a drop size of more than 3 mm, preferably more than 4 mm, and particularly preferably more than 5 mm, in the pipette test. Suitable alloys for producing aluminum layers or foils are commercially available under the names EN AW 1200, EN AW 8079, or EN AW 8111 from Hydro Aluminum Deutschland GmbH or Amcor Flexibles Singen GmbH. In the case of a metal foil as a barrier layer, an adhesion promoter layer can be provided on one and/or both sides of the metal foil between the metal foil and a nearest polymer layer.

Furthermore, an oxide layer can preferably be selected as the barrier layer according to alternative c. Oxide layers that are familiar to the person skilled in the art and that appear suitable for achieving a barrier effect against light, vapor and/or gas can be considered as oxide layers. A preferred oxide layer is a semimetal oxide layer or a metal oxide layer or both. A preferred semimetal oxide layer is a layer based on one or more silicon oxide compounds (SiOx layer). Preferred metal oxide layers are layers based on the previously mentioned metals aluminum, iron, or copper, as well as metal oxide layers based on titanium oxide compounds, with an aluminum oxide layer (AlOx layer) being particularly preferred. According to a preferred embodiment, the oxide layer can be present as a deposited layer. A deposited oxide layer is produced, for example, by vapor deposition of the oxide layer on a barrier substrate. A preferred method for this is physical vapor deposition (PVD) or chemical vapor deposition (CVD), preferably plasma-assisted. The oxide layer is preferably a continuous layer.

The barrier substrate can consist of any material which appears to the person skilled in the art to be suitable for use as a barrier substrate according to the invention. The barrier substrate is preferably suitable for being coated with an oxide layer. Preferably, a layer surface is sufficiently smooth for this purpose. Further preferably, the barrier substrate has a thickness in a range from 3 to 30 μm, preferably from 2 to 28 μm, more preferably from 2 to 26 μm, more preferably from 3 to 24 μm, more preferably from 4 to 22 μm, most preferably from 5 to 20 μm. Furthermore, the barrier substrate preferably has a barrier effect against oxygen or water vapor or both. Preferably, a barrier effect of the barrier substrate against permeation of oxygen is greater than a barrier effect of the oxide layer against permeation of oxygen. Preferably, the barrier substrate has an oxygen permeation rate in a range from 0.1 to 50 cm³/(m²·d·bar), preferably from 0.2 to 40 cm³/(m²·d· bar), more from preferably 0.3 to 30 cm³/(m²·d·bar). A preferred barrier substrate comprises, more preferably consists of, cellulose or a polymer or both. A preferred polymer here is an oriented polymer. Preferably, the oriented polymer is mono-axially oriented or bi-axially oriented. A further preferred polymer is a thermoplastic polymer. Preferably, the barrier substrate consists of the polymer. Preferably, the barrier substrate comprises a polymer selected from the group consisting of a polycondensate, a polyethylene, a polypropylene, a polyvinyl alcohol, or a combination of at least two thereof in a proportion of at least 50 wt. %, preferably of at least 60 wt. %, more preferably of at least 70 wt. %, more preferably of at least 80 wt. %, most preferably of at least 90 wt. %, based in each case on the weight of the barrier substrate. More preferably, the barrier substrate consists of the aforementioned polymer. A preferred polypropylene is oriented, in particular longitudinally stretched (oPP) or biaxially stretched (BoPP). A preferred polycondensate is a polyester or polyamide (PA) or both. A preferred polyester is one selected from the group consisting of a polyethylene terephthalate (PET), a polylactide (PLA), and/or a combination of at least two thereof. A preferred vinyl polymer is a vinyl alcohol copolymer or a polyvinyl alcohol or both. A preferred polyvinyl alcohol is a vinyl alcohol copolymer. A preferred vinyl alcohol copolymer is an ethylene-vinyl alcohol copolymer.

### Carrier Layer

Any material known to be suitable for this purpose to a person skilled in the art can be used as the carrier layer which has sufficient strength and rigidity to give the container stability to such an extent that the container substantially retains its shape when filled. This is in particular a necessary feature of the carrier layer since the invention relates to the technical field of dimensionally stable containers. Such dimensionally stable containers must be fundamentally distinguished from bags and pouches, which are usually made of thin foils. In addition to a number of plastics materials, plant-based fibrous materials, in particular cellulose, preferably glued, bleached and/or unbleached cellulose, are preferred, with paper and cardboard being particularly preferred. Accordingly, a preferred carrier layer comprises a plurality of fibers. The basis weight of the carrier layer is preferably in a range from 120 to 450 g/m², particularly preferably in a range from 130 to 400 g/m² and most preferably in a range from 150 to 380 g/m². A preferred cardboard usually has a single or multi-layer structure and can be coated on one or both sides with one or more cover layers. Furthermore, a preferred cardboard has a residual moisture content of less than 20 wt. %, preferably from 2 to 15 wt. % and particularly preferably from 4 to 10 wt. %, based on the total weight of the cardboard. A particularly preferred cardboard has a multi-layer structure. Furthermore, the cardboard preferably has at least one, but particularly preferably at least two, plies of a cover layer on the surface pointing toward the environment, which is known to the person skilled in the art as a “paper coating.” Furthermore, a preferred cardboard has a Scott bond value (according to Tappi 569) in a range from 100 to 360 J/m², preferably from 120 to 350 J/m² and particularly preferably from 135 to 310 J/m². The above-mentioned ranges make it possible to provide a composite from which a container can be folded with a high degree of tightness, easily and with low tolerances.

The carrier layer is characterized by bending stiffness. The carrier layer preferably has a bending stiffness in a first direction in a range of 80 to 550 mN. In the case of a carrier layer which comprises a plurality of fibers, the first direction is preferably an orientation direction of the fibers. A carrier layer comprising a plurality of fibers further preferably has a bending stiffness in a range from 20 to 300 mN in a second direction perpendicular to the first direction. A preferred sheet-like composite with the carrier layer has a bending stiffness in the first direction in a range from 100 to 700 mN. Furthermore, the aforementioned sheet-like composite preferably has a bending stiffness in the second direction in a range from 50 to 500 mN.

### Polyolefin

A preferred polyolefin is a polyethylene (PE) or a polypropylene (PP) or both. A preferred polyethylene is one selected from the group consisting of an LDPE, an LLDPE, and an HDPE, or a combination of at least two thereof. A further preferred polyolefin is a mpolyolefin (polyolefin produced using a metallocene catalyst). Suitable polyethylenes have a melt flow rate (MFI: melt flow index=MFR: melt flow rate) in a range from 1 to 25 g/10 min, preferably in a range from 2 to 20 g/10 min and particularly preferably in a range from 2.5 to 15 g/10 min, and a density in a range from 0.910 g/cm³ to 0.935 g/cm³, preferably in a range from 0.912 g/cm³ to 0.932 g/cm³, and more preferably in a range from 0.915 g/cm³ to 0.930 g/cm³.

### Mpolymer

An mpolymer is a polymer that has been produced using a metallocene catalyst. A metallocene is an organometallic compound in which a central metal atom is arranged between two organic ligands, such as cyclopentadienyl ligands. A preferred mpolymer is a mpolyolefin, preferably a mpolyethylene or a mpolypropylene or both. A preferred mpolyethylene is one selected from the group consisting of an mLDPE, an mLLDPE, and an mHDPE, or a combination of at least two thereof. A preferred mpolyolefin is characterized by at least a first melting temperature and a second melting temperature. Preferably, the mpolyolefin is characterized by a third melting temperature in addition to the first and second melting temperatures. A preferred first melting temperature is in a range from 84 to 108° C., preferably from 89 to 103° C., more preferably from 94 to 98° C. A preferred further melting temperature is in a range from 100 to 124° C., preferably from 105 to 119° C., more preferably from 110 to 114° C.

### Adhesion/Adhesion Promoter Layer

An adhesion promoter layer is a layer of the sheet-like composite which comprises at least one adhesion promoter in a sufficient amount so that the adhesion promoter layer improves adhesion between layers adjacent to the adhesion promoter layer. For this purpose, the adhesion promoter layer preferably comprises an adhesion promoter polymer. Accordingly, the adhesion promoter layers are preferably polymeric layers. An adhesion promoter layer can be located between layers of the sheet-like composite which do not directly adjoin one another, preferably between the barrier layer and the polymer inner layer. As adhesion promoters in an adhesion promoter layer, all plastics materials can be considered that are suitable for creating a permanent bond by forming ionic bonds or covalent bonds to a surface of an adjacent layer through functionalization by means of suitable functional groups. Preferably, they are functionalized polyolefins, in particular acrylic acid copolymers, which have been obtained by copolymerization of ethylene with acrylic acids such as acrylic acid, methacrylic acid, crotonic acid, acrylates, acrylate derivatives, or carboxylic acid anhydrides carrying double bonds, for example maleic anhydride, or at least two thereof. Preferred among these are polyethylene maleic anhydride graft polymers (EMAH), ethylene acrylic acid copolymers (EAA), or ethylene methacrylic acid copolymers (EMAA), which are marketed for example under the trade names Bynel® and Nucrel®0609HSA by DuPont, or Escor®6000ExCo by ExxonMobile Chemicals.

Ethylene-alkyl acrylate copolymers are also preferred as adhesion promoters. The alkyl group preferably selected is a methyl, ethyl, propyl, i-propyl, butyl, i-butyl, or a pentyl group. More preferably, the adhesion promoter layer may comprise mixtures of two or more different ethylene-alkyl acrylate copolymers. Also preferably, the ethylene alkyl acrylate copolymer may have two or more different alkyl groups in the acrylate function, e.g. an ethylene alkyl acrylate copolymer in which both methyl acrylate units and ethyl acrylate units occur in the same copolymer.

According to the invention, it is preferred that the adhesion between the carrier layer, a polymer layer, or the barrier layer and the next layer in each case is at least 0.5 N/15 mm, preferably at least 0.7 N/15 mm, and particularly preferably at least 0.8 N/15 mm. In an embodiment according to the invention, it is preferred that the adhesion between a polymer layer and a carrier layer is at least 0.3 N/15 mm, preferably at least 0.5 N/15 mm and particularly preferably at least 0.7 N/15 mm. Furthermore, it is preferred that the adhesion between the barrier layer and a polymer layer is at least 0.8 N/15 mm, preferably at least 1.0 N/15 mm, and particularly preferably at least 1.4 N/15 mm. In the event that the barrier layer indirectly follows a polymer layer via an adhesion promoter layer, it is preferred that the adhesion between the barrier layer and the adhesion promoter layer is at least 1.8 N/15 mm, preferably at least 2.2 N/15 mm, and particularly preferably at least 2.8 N/15 mm. In a special design, the adhesion between the individual layers is so strong that during the adhesion test a tear of the carrier layer, a so-called cardboard fiber tear in the case of cardboard as the carrier layer, occurs.

### Connecting

Any connecting that appears suitable to the person skilled in the art for use according to the invention and by means of which a sufficiently strong connection can be obtained can be considered as the connecting. A preferred connecting is a connecting with a material bond. A connection with a material bond is understood here to be a connection between joining partners that is created by attractive forces between materials or within a material. These are to be distinguished in particular from form-fit and force-fit connections, which are created by geometric shapes or frictional forces. A preferred connecting with a material bond can be one selected from the group consisting of sealing, welding, gluing, and pressing, or a combination of at least two thereof. The connecting with a material bond by means of a joining element is preferably a sealing, welding, or gluing, wherein the joining element serves as a sealing agent, welding additive, or adhesive. In the cases of sealing and welding, the connection is created by means of a liquid and its solidification. In the case of gluing, chemical bonds form between the boundary surfaces or surfaces of the two objects to be joined, creating the connection. When sealing, welding, or gluing, it is often advantageous to press together the surfaces to be sealed or glued. A preferred pressing of two layers is a pressing onto one another of a first surface of a first of the two layers onto a second surface, facing the first surface, of the second of the two layers over at least 20%, preferably at least 30%, more preferably at least 40%, more preferably at least 50%, more preferably at least 60%, more preferably at least 70%, even more preferably at least 80%, even more preferably at least 90%, most preferably at least 95%, of the first surface. A particularly preferred connecting is sealing or welding. A preferred sealing or welding process includes the steps of contacting, heating, and pressing, the steps preferably taking place in that order. A different order is also conceivable, in particular the order: heating, contacting, and pressing. A preferred heating is heating a polymer layer, preferably a thermoplastic layer, more preferably a polyethylene layer or a polypropylene layer or both. Another preferred heating is heating a polyethylene layer to a temperature in a range from 80 to 140° C., more preferably from 90 to 130° C., most preferably from 100 to 120° C. A further preferred heating is heating a polypropylene layer to a temperature in a range from 120 to 200° C., more preferably from 130 to 180° C., most preferably from 140 to 170° C. Another preferred heating is to a sealing temperature of the polymer layer. A preferred heating can be achieved by friction, radiation, hot gas, heat contact to a solid, mechanical vibrations, preferably ultrasound, convection, or a combination of at least two of these measures. A particularly preferred heating method is through friction between the joining partners or through excitation of an ultrasonic vibration or through both. In the latter case, the friction can be generated in particular by exciting an ultrasonic vibration of one or both joining partners. A preferred welding is frictional welding. The joining partners are moved relative to each other under pressure, with the joining partners touching each other. The resulting friction causes heating. The relative movement can be generated, for example, by an ultrasonic vibration. This procedure is also referred to herein as friction welding in the case of joining multi-layer composites (laminates).

### Foodstuffs

All foodstuffs for human consumption, and also animal feed, known to those skilled in the art can be considered as foodstuffs. Preferred foodstuffs are liquid above 5° C., such as dairy products, soups, sauces, and, preferably non-carbonated, beverages.

### Through-Hole

The at least one through-hole provided in a carrier layer according to preferred embodiments can have any shape known to the person skilled in the art suitable for various and for emptying the container. Furthermore, the through-hole is preferably suitable for opening the container with a drinking straw or an opening aid. Possible examples of opening aids are a pull tab and a screw cap. The through-hole is preferably covered with the corresponding layer in such a way that the through-hole is closed, preferably in watertight fashion. In the context of the invention, a through-hole for passing through a drinking straw is preferred. A preferred through-hole has a two-dimensional, rather than linear, opening area. Preferably, the through-hole is substantially circular, oval, elliptical, or droplet-shaped. The shape of the at least one through-hole in the carrier layer usually also determines the shape of the opening, which is created either by an openable closure connected to the container, through which the container contents are dispensed from the container after opening, or by a drinking straw in the container. Thus, the openings of the opened container often have shapes that are comparable or even identical to the at least one through-hole in the carrier layer. Container designs with a single through-hole in a carrier layer primarily serve to release the foodstuff in the container. A further through-hole in a carrier layer can be provided in particular for ventilation of the container when the foodstuff is released. In connection with the covering of the at least one through-hole in a carrier layer, the regions that cover the through-hole of the layers covering the same through-hole are also referred to as hole cover layers of the through-hole. These hole cover layers are preferably at least partially connected to one another, preferably over at least 30%, preferably at least 70%, and particularly preferably at least 90%, of the area formed by the at least one through-hole. It is further preferred that the hole cover layers are connected to one another at the edges of the at least one through-hole and preferably lie connected against the edges in order to achieve improved tightness via a connection extending over the entire hole surface. Frequently, the hole cover layers are connected to each other via the portion formed by the at least one through-hole in the carrier layer. This leads to a good tightness of the container formed from the composite and thus to the desired long shelf life of the foodstuffs stored in the container. Preferably, the at least one through-hole has a diameter in the range from 3 to 30 mm, more preferably from 3 to 25 mm, more preferably from 3 to 20 mm, more preferably from 3 to 15 mm, most preferably from 3 to 10 mm. Here the diameter of the through-hole is the length of the longest straight line that begins and ends at the edge of the through-hole and runs through the geometric center of gravity of the through-hole.

### Opening/Opening Aid

In most cases, an opening in the container is created by at least partially destroying the hole cover layers covering the at least one through-hole. This destruction can be done by cutting, pressing into the container, or pulling out of the container. The destruction can be carried out by an opening aid connected to the container and arranged in the region of the at least one through-hole, usually above the at least one through-hole, for example by a drinking straw which is pushed through the hole covering layers. Furthermore, in an embodiment according to the invention, it is preferred that an opening aid is provided in the region of the at least one through-hole. In this case, it is preferred that the opening aid is provided on the surface representing the outside of the container. Furthermore, the container preferably includes a closure, for example a lid, on the outside of the container. It is preferred that the closure covers the through-hole at least partially, preferably completely. The closure thus protects the container wall, which is less robust than the regions outside the at least one through-hole, from damaging mechanical influences. To open the hole cover layers covering at least one through-hole, the closure often includes the opening aid. Suitable as such are, for example, hooks for tearing out at least part of the hole cover layers, edges or blades for cutting into the hole cover layers, or thorns for pushing through the hole cover layers, or a combination of at least two thereof. These opening aids are often mechanically coupled to a screw lid or a cap of the closure, for example via a hinge, so that the opening aid acts on the hole cover layers to open the closed container when the screw lid or cap is operated. Occasionally, in the technical literature, such closure systems, comprising composite layers covering a through-hole and openable closures with opening aids covering this hole, are referred to as “overcoated holes” with “applied fitments”.

### Measurement Methods

The following measurement methods were used in the invention. Unless otherwise stated, the measurements were performed at an ambient temperature of 23° C., an ambient air pressure of 100 kPa (0.986 atm), and a relative humidity of 50%.

### Separating Individual Layers

If individual layers of a laminate, such as the barrier layer, are to be examined, the layer to be examined is first separated from the laminate as described below. Three samples of the sheet-like composite are cut to size. For this purpose, unless otherwise stated, unfolded and ungrooved portions of the sheet-like composite are used. Unless otherwise stated, the sample pieces have dimensions of 4 cm×4 cm. If other dimensions of the layer to be examined are necessary for the examination to be carried out, sufficiently large sample pieces are cut from the laminate. The samples are placed in an acetic acid bath (30% acetic acid solution: 30 wt. % CH₃COOH, remainder 100 wt. % H₂O) heated to 60° C. for 30 minutes. This causes the layers to detach from each other. Here the layers can also be carefully peeled away from each other manually if necessary. If the desired layer cannot be removed sufficiently well, new sample pieces are used as an alternative and treated in an ethanol bath (99% ethanol) as described above. If there are residues of the carrier layer (especially in the case of a cardboard layer as the carrier layer) on the layer to be examined (e.g. the polymer outer layer or the polymer intermediate layer), these are carefully removed with a brush. A sample of sufficient size for the examination to be carried out (unless otherwise stated with an area of 4 cm²) is cut out from each of the three films prepared in this way. These samples are then stored at 23° C. for 4 hours and thus dried. The three samples can then be examined. Unless otherwise stated, the test result is the arithmetic mean of the results for the three samples.

### MFR Value

The MFR is measured according to ISO 1133-1:2012, Method A (mass determination method), unless otherwise stated at 190° C. and 2.16 kg.

### Density

The density is measured according to ISO 1183-1:2013.

### Scott Bond Value

The Scott bond value is determined according to Tappi 569.

### Melting Temperature

The melting temperature is determined using the DSC method ISO 11357-1, -5. The device calibration is carried out according to the manufacturer's instructions using the following measurements:
Temperature indium-Onset temperature,
Heat of melting indium,
Temperature Zinc-onset temperature.

The recorded measurement curve can have a plurality of local maxima (melting peaks), i.e. a plurality of melting temperatures. If a melting temperature above a certain value is required, this condition is met if one of the measured melting temperatures is above this value. When reference is made herein to a melting temperature of a polymer layer, a polymer composition or a polymer, in the case of several measured melting temperatures (melting peaks), this always refers to the highest melting temperature, unless otherwise stated.

### Viscosity Number of PA

The viscosity number of PA is measured according to DIN EN ISO 307 (2013) in 95% sulfuric acid.

### Molecular Weight Distribution

The molecular weight distribution is measured by gel permeation chromatography using light scattering: ISO 16014-3/-5 (2009-09).

### Moisture Content of the Cardboard

The moisture content of the cardboard is measured according to ISO 287:2009.

### Adhesion

To determine the adhesion of two adjacent layers, they are fixed on a 90° peel test device, for example “German rotating wheel fixture” of the company Instron, on a rotating roller that rotates at 40 mm/min during the measurement. The samples were previously cut into strips 15 mm in width. On one side of the sample, the layers are detached from each other and the detached end is clamped in a pulling device directed vertically upwards. A measuring device for determining the pulling force is attached to the pulling device. As the roller rotates, the force required to separate the layers from each other is measured. This force corresponds to the adhesion of the layers to each other and is indicated in N/15 mm. The separation of the individual layers can be achieved mechanically, for example, or by targeted pretreatment, for example by soaking the sample for 3 minutes in 30% acetic acid at 60° C.

### Bending Stiffness

The following devices are used to determine the bending stiffness of a sheet-like material, in particular a sheet-like composite or cardboard:
Bending stiffness measuring device L&W Bending Tester Code 160, Type 977682 from Lorentzen & Wettre, Sweden,
Punch for bending stiffness samples.

The material to be tested is conditioned for 24 hours in a standard climate (23° C., 50% relative humidity). The measurement is also carried out in the standard climate. The punch is used to punch out samples with a width of 38.1 mm and a length of 69.85 mm from the material to be tested. For roll goods, samples are taken at 5 positions distributed across the web width. For each position, 2 samples are punched with their length in the running direction (machine direction-MD) and 2 samples with their length transverse to the running direction (cross direction-CD) to obtain a total of 10 samples in MD and 10 samples in CD. In each case, at least 4 samples should be taken, half of the samples with their length in MD and the other half with their length in CD. Samples must be taken only from ungrooved and unfolded portions of the material to be tested.

The bending stiffness (in mN) of the outer side and the opposite inner side is determined, both in MD and CD. To do this, the sample is placed in the test device with the side to be measured facing forward and the measurement is started by pressing the green button. For each of the combinations outside/MD, outside/CD, inside/MD and inside/CD, the same number of samples is measured. A 2-point bending test is carried out by the bending stiffness measuring device. The sample, clamped at one end, is deflected at its other end by a measuring edge through a bending angle of 15°. Here, a direction in which the material has bending stiffness is the direction of a straight line connecting the two points of application of the 2-point bending test. In the case of the bending stiffness measuring device, this direction is the direction of the shortest straight line from the clamp to the measuring edge. In this direction, the sample forms a curve when bent. A straight fold line would form perpendicular to this direction if the sample were bent far enough. The free clamping length of the sample is 50 mm. Each sample must be used for only one measurement. Measurements of the outside and the inside of the same sample are not permitted. The individual measured values are read from the display.

If for each of the combinations outer side/MD, outer side/CD, inner side/MD and inner side/CD a plurality of samples were measured, the arithmetic mean of the samples is calculated for each of the combinations individually. The arithmetic means are subsequently used as values for each of the 4 Combinations. The bending stiffness in MD or CD is the geometric mean of the values for the combinations outside/MD and inside/MD or outside/CD and inside/CD. The direction-independent bending stiffness (herein “bending stiffness”) is the geometric mean of the values for all 4 combinations outside/MD, outside/CD, inside/MD and inside/CD.

### Drop Simulation

For this purpose, the filled and closed container is inserted from above into a vertically suspended guide tube with a diameter adapted to the container size and then dropped. The tube has a length of about 1.5 m and is suspended 1 m above the ground. By guiding the container for the first 1.5 m of the fall in the tube, it is possible to let it fall reproducibly onto the container bottom or the container top in order to be able to investigate the effects on the container integrity.

Liquid Tightness Crystal Oil 60 from Shell Chemicals with methylene blue is used as a test agent for testing the tightness of the containers. Depending on the examination criterion, the container to be examined may be subjected to the corresponding drop simulation. The container is cut open along its circumference by a cut through the jacket element so that an open, cup-like container part comprising the closed container bottom and an open, cup-like container part comprising the closed container head are obtained. The first container part with the container bottom and the second container part with the container head are each first emptied and then filled with an amount of the test agent that is sufficient to completely cover the bottom of the respective cup-like container part. In particular, any sealing seam between the jacket element and an end element should be completely covered with the test agent. The container parts are then stored for 24 hours. After the storage period, the outside of each container part is checked with the naked eye to see whether the test agent has caused blue discoloration in the event of a leak. If neither the first part of the container nor the second part of the container shows such discoloration, the container is considered liquid-tight.

If the tightness of container heads or container bottoms of different containers is to be compared, 500 identical containers of each container type to be compared are examined as described above. The result of the test is the number of 500 identical containers which show a leak after a storage period of 24 hours. These numbers are then compared for the different containers.

The invention is illustrated in more detail below by examples and drawings, wherein the examples and drawings do not limit the invention. Furthermore, unless otherwise indicated, the drawings are not true to scale.

Laminate construction In the examples (according to the invention) and comparative examples (not according to the invention), laminates with the layer structure indicated in Table 1 below were used to produce containers.

TABLE 1
Structure of the laminates of the examples
and the comparative examples

| | | Basis weight |
|---|---|---|
| Layer designation | Material | [g/m²] |
| Polymer outer layer | LDPE 23L430 of Ineos GmbH, | 15 |
| | Cologne, Germany | |
| Carrier layer | Cardboard: Stora Enso Natura T | 210 |
| | Duplex double-coated, Scott | |
| | bond 200 J/m², residual moisture | |
| | 7.5%, bending stiffness 104 mN | |
| Polymer intermediate | LDPE 23L430 of Ineos GmbH, | 18 |
| layer | Cologne, Germany | |
| Adhesion promoter | Escor 6000 HSC of Exxon | 3 |
| layer | Mobil Corporation | |
| Barrier layer | Aluminum, EN AW 8079 of Hydro | here: |
| | Aluminium Deutschland GmbH | thickness |
| | | 6 μm |
| Polymer inner layer | LDPE 23L430 of Ineos GmbH, | 15 |
| | Cologne, Germany | |

### Laminate Production

The laminates for the examples and comparative examples are produced using an extrusion coating system from Davis Standard. The extrusion temperature is in a range from approximately 280 to 330° C. In the first step, the polymer outer layer is coated over the entire surface of the carrier layer by layer extrusion. In the second step, the barrier layer together with the adhesion promoter layer and the polymer intermediate layer as a laminating agents is applied over the entire surface of the carrier layer previously coated with the polymer outer layer. The polymer inner layer is then extruded over the entire surface of the barrier layer. To apply the individual layers by extrusion, the polymers are melted in an extruder. When a polymer is applied in a layer, the resulting melt is transferred via a feed block into a nozzle and extruded onto the carrier layer.

### Container Production

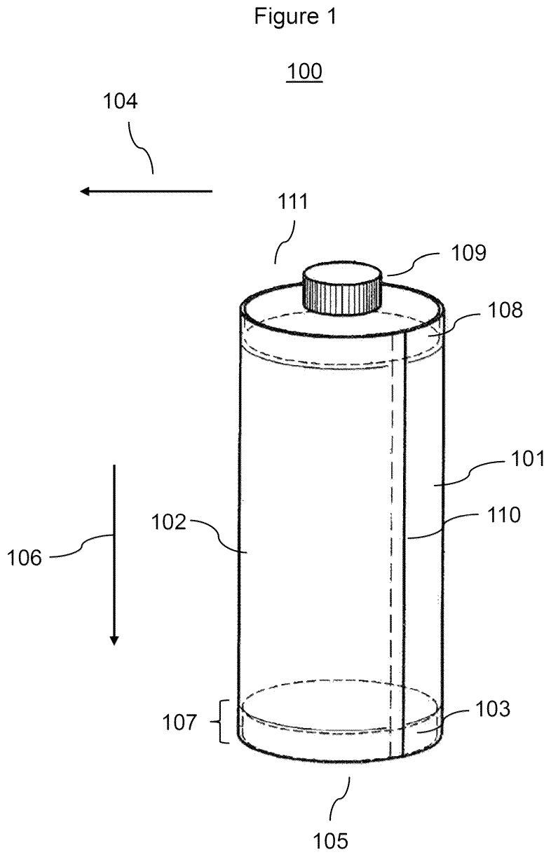

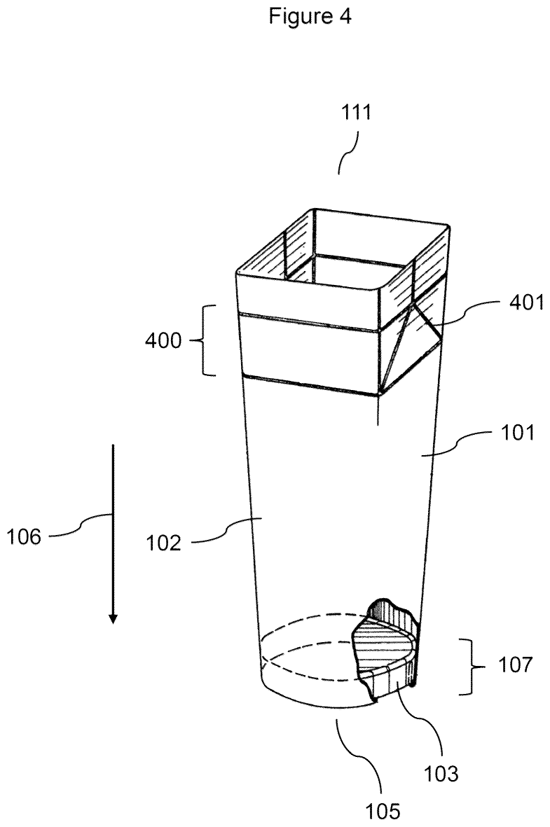

Elements of the container wall are separated by punching from the laminates obtained as described above. For each container, a rectangular jacket element 101 and a circular end element 103 (for the container bottom) are punched out. For each container with a 3-part container wall, a molded plastics material part is also provided as an end element 108 for the container head (see FIG. 1). This has a pouring hole 109 in the center. Such a circular end element 108 can be manufactured by injection molding. In the case of a container with a two-part container wall, the jacket element 101 of the container is provided with grooves 401 on the outside (side of the polymer outer layer) before punching, which predefine fold lines for forming and closing the container head (see FIG. 4).

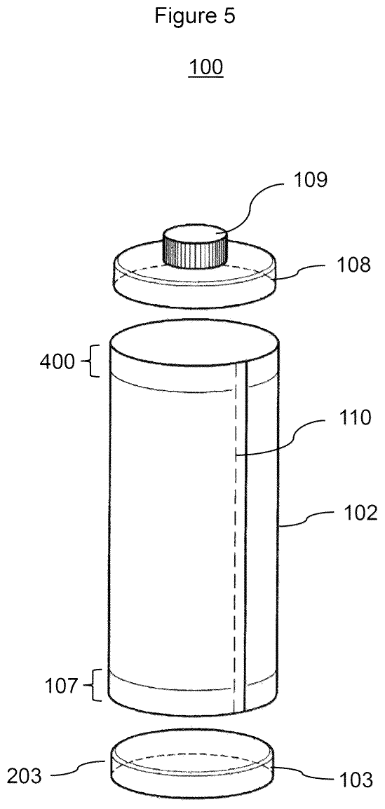

By overlapping contacting and sealing opposite longitudinal edges of each jacket element 101, the latter is formed into a hollow cylindrical structure of the type shown in FIG. 5. Sealing is carried out here as heat sealing by blowing hot air and with the polymer inner layer as a sealing agent, forming a longitudinal seam 110.

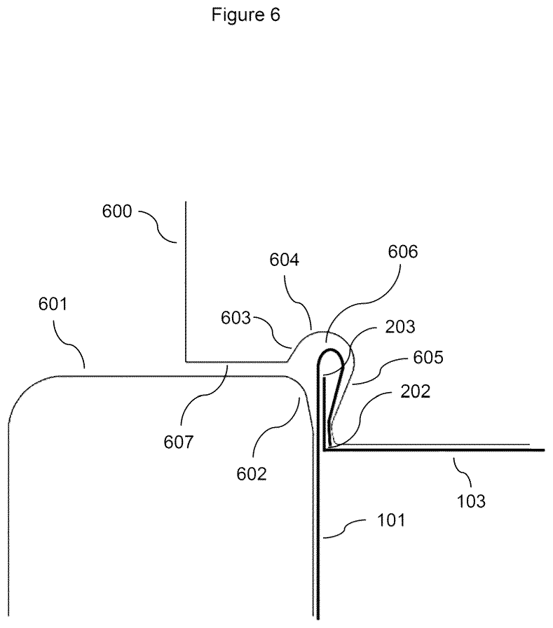

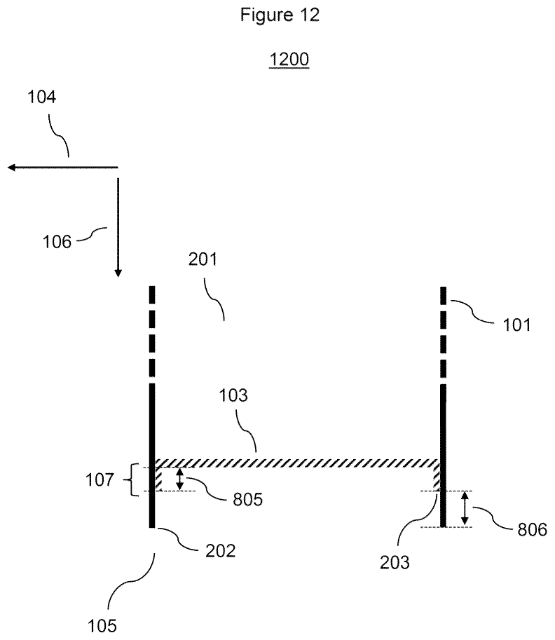

The hollow cylindrical structure thus obtained is placed into a precisely fitting cylindrical opening of a steel mold acting as an anvil 601 (see FIG. 6), the lower edge of the structure being flush with the edge of the opening. The end element 103 for the bottom is now pressed into the opening with the polymer inner layer first by engaging a suitable tool in the opening, obtaining a precursor 1200 (see FIG. 12).

In this container precursor 1200, the lower edge is then flanged as shown in FIG. 6, wherein the end element 103 is connected to the jacket element 101 by ultrasonic friction welding. The exact geometry of the sealing seam thus obtained is determined by the design of the sonotrode 600 and the anvil 601 used for welding, in particular by the angles at which the surfaces of the tools engaging the container parts are positioned relative to one another during sealing.

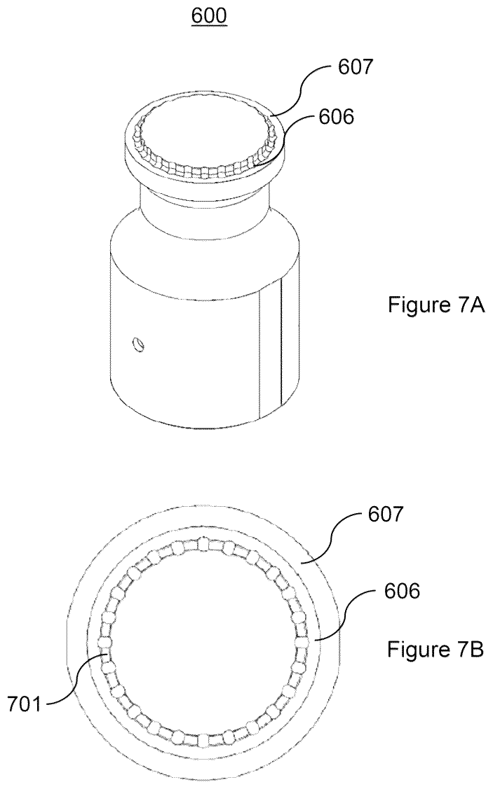

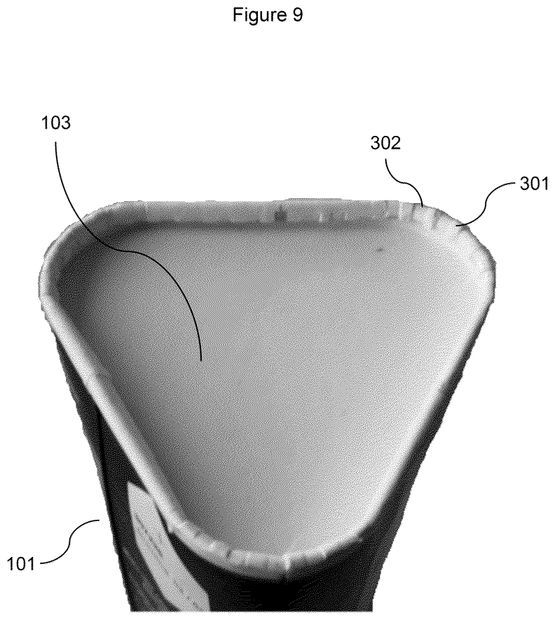

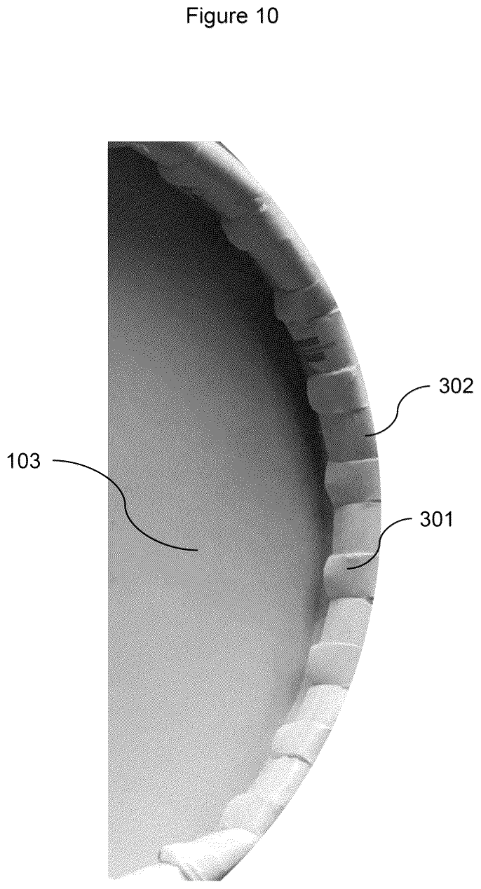

In order to flange the lower edge of the jacket element 102, a sonotrode 600 is used (see FIG. 6), which is moved in the direction of its longitudinal axis, i.e. vertically in FIG. 6, towards the lower edge of the jacket element 102. The sonotrode 600 has a groove 606 with a first wall 603, a second wall 605 and a groove bottom 604 which is concavely curved, i.e. is provided with a radius of curvature. During the relative movement of the sonotrode 600 in the direction of the edge of the jacket element 102, i.e. in the vertical direction, the first edge 202 of the jacket element 102 first comes into contact with the first wall 603 of the sonotrode 600, which is inclined with respect to the vertical direction, i.e. with respect to the longitudinal axis of the sonotrode, at an angle of inclination that is greater than 0 and less than 90°. As soon as the first edge 202 of the jacket element 102 comes into contact with the inclined wall 603, the first edge 202 of the jacket element 102 is bent inwards, i.e. to the right in the figure. As soon as the first edge 202 then comes into contact with the groove bottom 604, the bending of the first edge 202 of the jacket element 102 is further increased until the first edge 202 of the jacket element 102 reaches the second wall 605 and then assumes approximately the position shown in FIG. 6. The anvil 601 has a conical sealing surface 602 such that the distance between the wall 605 and the conical sealing surface 602 is reduced when the sonotrode 600 moves towards the anvil 601, i.e. in the direction of the longitudinal axis. Therefore, the tool not only flanges the lower edge of the container 100, but also welds the flanged edge portion to the bottom element 103 and the jacket element 102, so that the flange provides additional support for the bottom. The position shown in FIG. 6 is the welding position. Between the described starting position and the welding position shown is the flanging position, during which the jacket element 102 comes into contact with the groove walls 603 and 604 and the groove bottom 605 one after the other and is bent. As shown in FIGS. 7A and 7B, the sonotrode 600 has a plurality of recesses 701 in the groove 606 which, in the production of a container 100 according to the invention, result in a plurality of regions 301 of a first type and a plurality of regions 302 of a further type being formed in the edge region at least on an inward-facing side in the direction counter to the transverse direction, as shown in FIGS. 9 and 10. In the circumferential direction of the container, the portions 301 of the first type each have a first length of 3 mm. The portions 302 of the further type have a further length of 4 mm in the same direction. In a comparison test, a conventional sonotrode is used which has no recesses 701 in the groove. As a result, during the flanging the bottom element 103 forms distortions that are distributed irregularly along the circumference of the container. These distortions include folds running perpendicular to the direction of the container circumference, which form lower-lying portions. These lower-lying portions are no wider than 0.2 mm in the direction of the container circumference. The higher-lying portions located between the folds have widths in the range of 3 to 11 mm in the direction of the container circumference.

TABLE 2
Shape of the bottom seam

| | Information on the bottom seam |
|---|---|
| Example | with corrugation of the bottom seam |
| Comparative example | Without corrugation of the bottom seam |

### Evaluation

500 containers of the example and the comparative example are subjected to the liquid determination test described above. The results of this test are summarized in Table 3. For each criterion, +++means a better result than ++, which means a better result than +, which in turn means a better result than 0, which in turn means a better result than −, which in turn means a better result than −−.

TABLE 3
Overview of advantages and disadvantages of the containers
of the comparative examples and examples

| | Liquid tightness of container bottom after |
|---|---|
| | drop simulation on container bottom |
| Comparative example | +++ |
| Example | −− |

### FURTHER EXAMPLES

In further comparative tests, 100 containers are produced for each further example A to F as described above for the example according to the invention. The overhang length 806 explained in FIG. 6 is varied. In Table 4, the overhang length 806 for each of the 100 containers of the further examples is given as a percentage of the height 805 of the bottom element 103. It should be noted that the overhang length 806 also includes the part of the rim portion 107 which does not run vertically but is bent around the further edge 203. The overhang length 806 is therefore the total length of the dashed line in FIG. 6.

The containers of the further examples A to F are subjected to the drop simulation onto the container bottom described above. Thereafter, for each further example, the number of containers is counted in which the seal of the flanged rim portion 107 has come loose at least at one point along the container circumference. The larger the proportion of containers with such an open flange, the worse the corresponding further example is rated.

TABLE 4
Overview of advantages and disadvantages of
the containers in the further examples A to F

| | Overhang length in % | Proportion of containers |
|---|---|---|
| | of the height of the | with open flange after |
| | bottom element | drop simulation |
| Example A | 25 | − |
| Example B | 30 | 0 |
| Example C | 40 | + |
| Example D | 50 | ++ |
| Example E | 100 | ++ |
| Example F | 110 | − |

In Table 4, for each criterion, ++means a better result than +, which means a better result than 0, which in turn means a better result than −.

In further comparison tests, per each further example G to J 100 containers are manufactured as described above for the example according to the invention. The method used to flange the container bottom is varied. In examples I and J, flanging is carried out using ultrasound as described above. In example I, the ultrasonic vibration of the sonotrode is already activated in the starting position, i.e. before the tools engage, and remains activated until the welding (pre-oscillation). In example J, the ultrasonic vibration is only activated in the welding position. In examples G and H, the flanging is done not with ultrasound but with heated flanging tools. In example G, the containers are flanged one after the other as quickly as possible without the tools cooling down between successive flanging processes. In example H, after each flanging process waiting takes place until the flanging tools have cooled down to a temperature of 80° C. This reduces softening and sticking of the polymer outer layer of the following container to the tools during the flanging process. This extends the maintenance interval of the flanging tools because they need to be cleaned less often of polymer deposits in order to prevent the outside of subsequent containers from becoming contaminated, or even sticking of the flanging tools to the finished welded container and thus damaging its outside.

The containers of the other further G to J are also subjected to the drop simulation onto the container bottom as described above. Thereafter, for each further example, the number of containers is counted in which the seal of the flanged rim portion 107 has come loose at least at one point along the container circumference. The larger the proportion of containers with such an open flange, the worse the corresponding further example is rated. In Table 5, for each criterion, ++means a better result than +, which means a better result than 0, which in turn means a better result than −. These relative indications relate only to the results given in Table 5.

TABLE 5
Overview of advantages and disadvantages of the containers in the further examples G to J

| | | | | | | Proportion of |
|---|---|---|---|---|---|---|
| | | | | | | containers |
| | | | | | | with open |
| | | | | Maintenance | | flange after |
| | Flanging | Cooling | Pre- | interval of the | Duration of | drop |
| | method | the tools | oscillation | flanging tools | flanging | simulation |
| Example G | Heated | no | / | − | 0 | 0 |
| | tools | | | | | |
| Example H | Heated | Yes | / | 0 | − | 0 |
| | tools | | | | | |
| Example I | Ultrasonic | / | no | + | + | + |
| Example J | Ultrasonic | / | Yes | + | + | ++ |

Unless otherwise indicated in the description or the respective drawing, the drawings show, schematically and not to scale:

FIG. 1 a schematic representation of a liquid-tight container according to the invention;

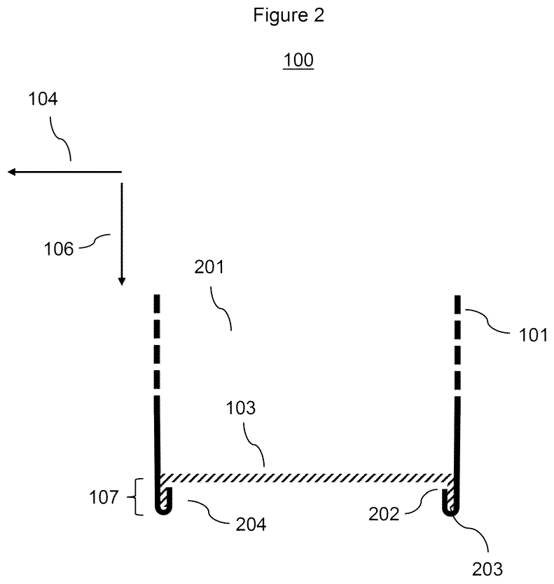

FIG. 2 a schematic cross-sectional view of the container bottom of the liquid-tight container of FIG. 1;

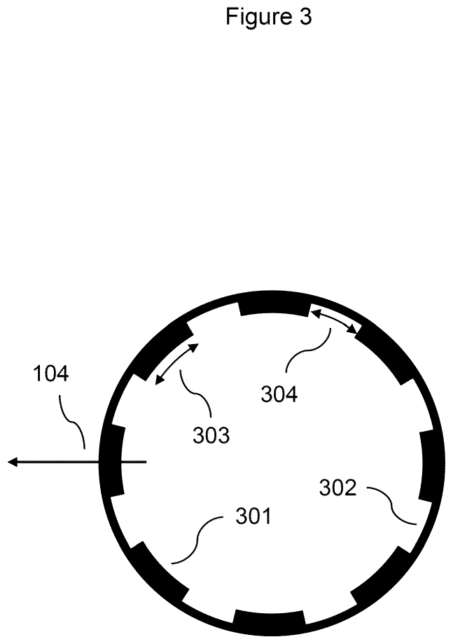

FIG. 3 a schematic representation of the bottom of the liquid-tight container 100 according to the invention in a view from below;

FIG. 4 a schematic representation of a liquid-tight container 100 according to the invention, which is not yet closed at its upper end;

FIG. 5 an exploded view of the liquid-tight container 100 of FIG. 1;

FIG. 6 a schematic representation of the conditions of the flanging process when connecting the first end element to the rim portion 107 of the jacket element 102;

FIG. 7 a schematic representation of the sonotrode 600 as used in the process shown in FIG. 6;

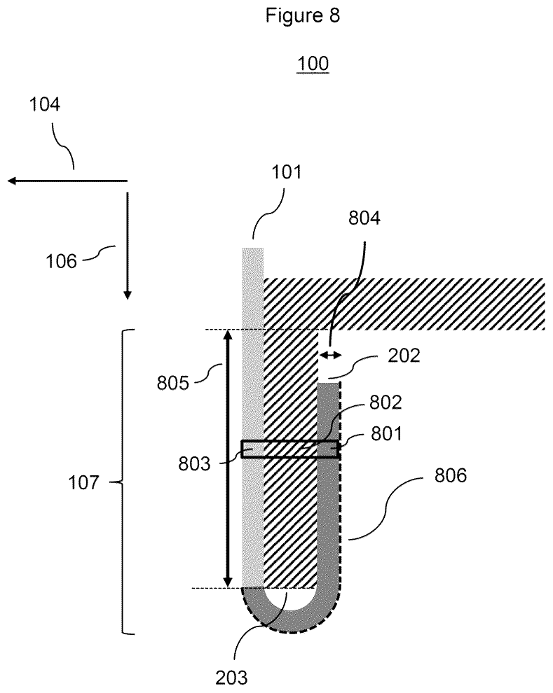

FIG. 8 a schematic representation of a preferred embodiment of the liquid-tight container 100 according to the invention in the rim portion 107 of the jacket element 101;

FIG. 9 a black and white photographic representation of the bottom of a liquid-tight container 100 according to the invention in a view from below;

FIG. 10 another black and white photographic representation of the bottom of a liquid-tight container 100 according to the invention in a view from below;

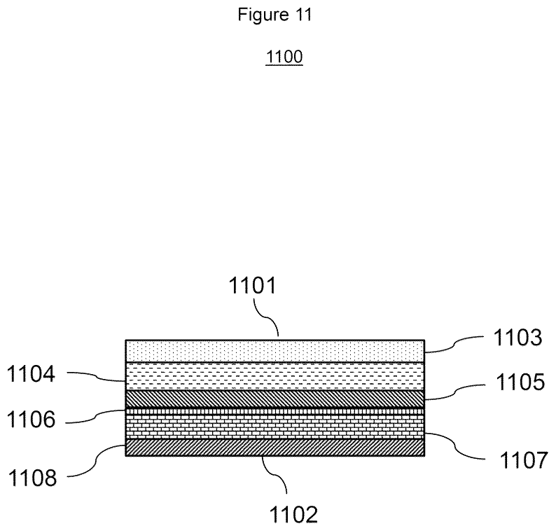

FIG. 11 a schematic cross-sectional representation of a sheet-like composite 1100;

FIG. 12 a schematic cross-sectional view at the lower end 105 of a precursor 1200 according to the invention for producing a liquid-tight container 100;

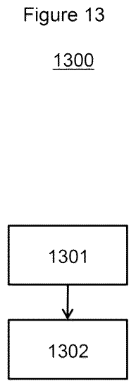

FIG. 13 a flow chart of a method 1300 according to the invention for producing a liquid-tight container 100.

FIG. 1 shows a schematic representation of a liquid-tight container 100 according to the invention, the container wall 101 of which is formed in three parts. In each case, a region of the container wall 101 surrounding a container interior 201 (see FIG. 2) is formed by a jacket element 102, a first end element 103, and a further end element 108. Both the jacket element 102 and the first end element 103 consist of the sheet-like composite 1100 shown in FIG. 11. Where the first end element 103 is formed from a circular piece of the sheet-like composite 1100, the jacket element 102 consists of a rectangular cut of the sheet-like composite 1100. Opposite longitudinal edges of this cut are contacted with each other in an overlapping manner and sealed together. The seam thus obtained is referred to as the longitudinal seam 110 of the container 100. The jacket element 102 laterally delimits the container interior 201, based on a length of the liquid-tight container 100. The first end element 103 delimits the container interior 201 in a first direction along a length of the container 100. In addition, the first end element 103, in relation to the length of the liquid-tight container 100, seals the liquid-tight container 100 at a first end 105 that is formed by a container bottom 103. The further end element 108 is a molded part made of plastics material with a circular shape in top view and a central pouring hole. The further end element 108 delimits the container interior 201 in a further direction counter to the first direction. Furthermore, the 100 comprises a closure lid 109. The pouring hole of the further end element 108 is located under this closure lid 109. A pull tab made of aluminum foil coated on both sides with LDPE is sealed over this pouring hole. The further end element 108 closes the liquid-tight container 100 together with the pull at a second end 111 opposite the first end 105 of the container 100, relative to the length of the liquid-tight container 100, which second end is formed by a container head 108. After the liquid-tight container has been opened by tearing off the pull tab, the closure lid 109 provides a means of closing the liquid-tight container 100 again, albeit significantly less tightly. Details of the container bottom 103 designed according to the invention can be seen in FIG. 2.

FIG. 2 shows a schematic cross-sectional view of the container bottom of the liquid-tight container of FIG. 1. The jacket element 102 delimits the container interior 201 in a transverse direction 104 running from the inside to the outside with respect to the container interior 201 and includes a rim portion 107 with a first edge 202. The first end element 103 delimits the container interior 201 at a first end 105 of the container 100 in a longitudinal direction 106 running along a length of the container and comprises a further edge 203 which points in the longitudinal direction 106. The rim portion 107 is arranged at the first end 105 of the liquid-tight container 100 and encloses the further edge 203 counter to the transverse direction 104 from the outside to the inside in such a way that the first edge 202 of the jacket element 101 points counter to the longitudinal direction 106, and the liquid-tight container 100 has a layer sequence at the first end 105 in the transverse direction 104 which comprises a first ply 801 of the jacket element 102, a ply 802 of the first end element 103, and a further ply 803 of the jacket element 102, as shown in FIG. 8. The rim portion 107 comprises, at least on a side 204 which faces inward counter to the transverse direction 104, a plurality of portions 301 of a first type and a plurality of portions 302 of a further type, as shown in FIG. 3.

FIG. 3 shows a schematic representation of the bottom of the liquid-tight container 100 according to the invention in a view from below, in which these portions 301 and 302 are shown. The portions 301 of the first type and portions 302 of the further type follow one another in a circumferential direction which runs along the further edge 203, wherein the first ply 801 (shown in FIG. 8) of the jacket element 102 has a thickness 804 in the transverse direction 104. The thickness 804 of the first ply 801 is a mathematical function of a position along the circumferential direction, the mathematical function having a plurality of local maxima and a plurality of local minima. Each portion 301 comprises exactly one of the local maxima and each further portion 302 comprises exactly one of the local minima. The thickness 804 of the first ply 801 in each entire first portion 301 is at least 0.7 times a value of the local maximum included by that first portion 301. The thickness 804 of the first ply 801 in each entire further portion 302 is at most 1.3 times a value of the local minimum included in that further portion 302. As can also be seen from FIG. 3, each portion 301 of the first type has a first length 303 in the circumferential direction and each portion 302 of the further type has a second length 304 in the circumferential direction. The liquid-tight container according to the invention is characterized in that every second length 304 is at least 10% of every first length 303.

FIG. 4 shows a schematic representation of a liquid-tight container 100 according to the invention, which is not yet closed at its further (upper) end 111. In order to facilitate the folding of the jacket element 102 to close the further end 111, the jacket element 101 has grooves 401 which predetermine the fold lines to be made. By folding along the grooves 401 and sealing the folding surfaces together, a liquid-tight container 100 can be obtained, the head portion of which has a gable-shaped configuration (not shown). FIG. 4 also shows the container bottom cut at the first end 105. This shows that the jacket element 102 completely surrounds the first end element 103 laterally.

FIG. 5 shows an exploded view of the liquid-tight container 100 of FIG. 1.

FIG. 6 shows a schematic representation of the conditions of the flanging process when connecting the first end element to the rim portion 107 of the jacket element 102, as described in detail above in the experimental part in the paragraph “container production”. FIG. 7 shows a schematic representation of the sonotrode 600 as it is used in this flanging process.

FIG. 8 shows a schematic representation of a preferred embodiment of the liquid-tight container 100 according to the invention in the rim portion 107 of the jacket element 101. According to this embodiment, the further edge 203 forms a closed curve with a third length along the circumferential direction, wherein the first end element 103 has a height 805 extending in the longitudinal direction 106 at each point of the closed curve. The rim portion 107 protrudes beyond the further edge 203 at every point of the closed curve such that the rim portion 107 extends from the further edge 203 to the first edge 202 by an overhang length 806, wherein the overhang length 806 is measured on a side of the rim portion 107 which faces away from the first end element 103 (it therefore corresponds to the length of the dashed line in FIG. 8). Preferably, the overhang length 806 along at least 50% of the third length is 30 to 100% of the height 805.

FIG. 9 shows a black-and-white photographic representation of the bottom of a liquid-tight container 100 according to the invention in a view from below, in which the portions 301 and 302 are shown. The liquid-tight container 100 shown in FIG. 9 is a container in which the jacket element (and accordingly also the first end element forming the bottom portion) has a substantially triangular cross-section. To produce such a container, a sonotrode 600 is to be used in the flanging process described in FIG. 6, which, in contrast to the circular shape shown in FIG. 7, has a corresponding triangular shape.

FIG. 10 shows a black-and-white photographic representation of a detail of the bottom of a liquid-tight container 100 according to the invention in a view from below, in which the portions 301 and 302 are again shown. The liquid-tight container 100 shown in FIG. 9 is a container in which the jacket element (and accordingly also the first end element forming the bottom portion) has a substantially circular cross-section.

FIG. 11 shows a schematic cross-sectional view of a sheet-like composite 1100. From its outer surface 1101 towards its inner surface 1102, this consists of the following layers overlapping each other over their entire surfaces: polymer outer layer 1103, carrier layer 1104, polymer intermediate layer 1105, adhesive layer 1106, and polymer inner layer 1108. Suitable materials and basis weights of the layers are given in Table 1 above.

FIG. 12 shows a schematic cross-sectional view at the lower end 105 of a precursor 1200 according to the invention for producing the inventive liquid-tight container 100. The precursor 1200 includes a container wall 101 that at least partially surrounds the container interior 201, wherein the jacket element 102 and the first end element 103 are connected to one another and each form a portion of the container wall 101. The jacket element 102 delimits the container interior 102 in the transverse direction 104 and includes rim portion 107 with the first edge 202. The first end element 103 delimits the container interior 201 at a first end 105 of the precursor in the longitudinal direction 106 and comprises the further edge 203, wherein the rim portion 107 is arranged at the first end 105 of the precursor 1200. The first edge 202 and the further edge 203 point in the longitudinal direction 106. The further edge 203 forms a closed curve with a third length, wherein the first end element 103 has a height 805 (shown in FIG. 8) extending in the longitudinal direction 106 at each point of the closed curve. The rim portion 107 protrudes beyond the further edge 203 at every point of the closed curve such that the rim portion 107 extends from the further edge 203 to the first edge 202 by an overhang length 806, wherein the overhang length 806 is measured on a side of the rim portion 107 which faces away from the first end element 103. The overhang length 806 along at least 50% of the third length is 30 to 100% of the height 805.

FIG. 13 shows a flow chart of a method 1300 according to the invention for producing a liquid-tight container 100. In method step 1301, a precursor 1200 according to the invention, as shown in FIG. 12, is provided. The precursor 1200 includes a container wall 101 at least partially surrounding a container interior 201, wherein a jacket element 102 and a first end element 103 are connected to one another and each form a portion of the container wall 101. The jacket element 102 delimits the container interior 201 in a transverse direction 104 running from the inside to the outside in relation to the container interior 201 and includes a rim portion 107 with a first edge 202. The first end element 103 delimits the container interior 201 at a first end of the 105 precursor 1200 in a longitudinal direction 106 running along a length of the precursor 1200 and includes a further edge 203, wherein the rim portion 107 is arranged at the first end 105 of the precursor 1200 and wherein the first edge 202 and the further edge 203 point in the longitudinal direction 106. In method step 1302, the rim portion 107 is formed by contacting with a forming tool, as shown in FIG. 6. The rim portion 107 encloses the further edge 203 counter to the transverse direction 104 from the outside to the inside in such a way that the first edge 202 of the jacket element 102 points counter to the longitudinal direction 106, and the precursor 1200 or the liquid-tight container 100 obtained therefrom has a layer sequence at the first end 105 in the transverse direction 104 which includes a first ply 801 of the jacket element 102, a ply 802 of the first end element 103 and a further ply 802 of the jacket element 102 (as shown in FIG. 8). During forming, the forming tool executes an oscillation with 10 a frequency in the range from 15 to 50 kHz.

### LIST OF REFERENCE SIGNS

100 liquid-tight container according to the invention
101 container wall
102 jacket element
103 first end element, preferably container bottom
104 transverse direction
105 first end of the liquid-tight container 100
106 longitudinal direction
107 rim portion of the jacket element 102
108 further end element, preferably container head
109 closure lid
110 longitudinal seam
111 second end of the liquid-tight container 100
201 container interior
202 first edge of the rim portion 207
203 further edge of the first end element 103
204 inward-facing side of the rim portion
301 plurality of portions of a first type
302 plurality of portions of a further type
303 first length of the portion 301 of the first type
304 first length of the portion 302 of the further type
400 upper rim portion of the jacket element
401 groove
600 sonotrode
601 counter-tool (anvil)
602 conical sealing surface
603 first wall of the groove
604 groove bottom
605 second wall of the groove
606 groove or slot
607 end face portion
701 recesses in the groove 606
801 first ply of the jacket element 101
802 ply of the first end element 103
803 further ply of the jacket element 101
804 thickness of the first ply 801 of the jacket element 101
805 height of the first end element 103 in the longitudinal direction 106
806 overhang length
1100 sheet-like composite
1101 outer surface
1102 inner surface
1103 polymer outer layer
1104 carrier layer
1105 polymer intermediate layer
1106 adhesive layer
1107 barrier layer
1108 polymer inner layer
1200 precursor
1300 method according to the invention for producing a liquid-tight container
1301 method step a)
1302 method step b)

1. A liquid-tight container, comprising a container wall which surrounds a container interior at least in part;
wherein a jacket element and a first end element are connected to one another and each form a portion of the container wall;
wherein the jacket element
delimits the container interior in a transverse direction extending from the inside to the outside in relation to the container interior, and
comprises a rim portion having a first edge;
wherein the first end element
delimits the container interior at a first end of the liquid-tight container in a longitudinal direction extending along the length of the liquid-tight container, and
comprises a further edge which points in the longitudinal direction;
wherein the rim portion
a. is located at the first end of the liquid-tight container, and
b. encloses the further edge counter to the transverse direction from the outside to the inside in such a way that
i. the first edge of the jacket element points counter to the longitudinal direction, and
ii. the liquid-tight container comprises, at the first end in the transverse direction, a ply sequence comprising
A. a first ply of the jacket element,
B. a ply of the first end element, and
C. a further ply of the jacket element;
wherein the rim portion comprises, at least on an inward-facing side counter to the transverse direction, a plurality of portions of a first type and a plurality of portions of a further type;
wherein the portions of the first type and the portions of the further type follow one another in a circumferential direction that extends along the further edge;
wherein the first ply of the jacket element has a thickness in the transverse direction;
wherein the thickness of the first ply is a mathematical function of a position along the circumferential direction;
wherein the mathematical function has a plurality of local maxima and a plurality of local minima;
wherein each portion of the first type comprises exactly one of the local maxima and each portion of the further type comprises exactly one of the local minima;
wherein the thickness of the first ply in each entire portion of the first type is at least 0.7 times a value of the local maximum comprised by the respective portion of the first type;
wherein the thickness of the first ply in each entire portion of the further type is at most 1.3 times a value of the local minimum comprised by the respective portion of the further type;
wherein each portion of the first type has a first length in the circumferential direction;
wherein each portion of the further type has a second length in the circumferential direction;
characterized in that each second length is at least 10% of each first length.

2. The liquid-tight container according to claim 1, wherein the value of each local minimum is 10 to 80% of the value of each local maximum.

3. The liquid-tight container according to claim 1, wherein the further edge forms a closed curve with a third length along the circumferential direction;
wherein the first end element has a height extending in the longitudinal direction at each point of the closed curve;
wherein the rim portion protrudes beyond the further edge at each point of the closed curve such that the rim portion extends from the further edge to the first edge by an overhang length;
wherein the overhang length is measured on a side of the rim portion facing away from the first end element;
wherein the overhang length along at least 50% of the third length is 30 to 100% of the height.

4. The liquid-tight container according to claim 1, wherein the jacket element is at least partially formed from a first sheet-like material.

5. The liquid-tight container according to claim 4, wherein the first sheet-like material is a first sheet-like composite comprising a first layer sequence;
wherein the first layer sequence comprises a first carrier layer.

6. The liquid-tight container according to claim 4, wherein the first carrier layer in the first layer sequence is overlaid with a first polymer inner layer on a side facing the container interior.

7. The liquid-tight container according to claim 5, wherein the first carrier layer in the first layer sequence is overlaid with a first polymer outer layer on a side facing away from the container interior.

8. The liquid-tight container according to claim 7, wherein the first layer sequence between the first carrier layer and the first polymer inner layer comprises a first barrier layer.

9. A precursor for producing the liquid-tight container according to claim 1, the precursor comprising a container wall which surrounds the container interior at least in part;
wherein the jacket element and the first end element are connected to one another and each form a portion of the container wall;
wherein the jacket element
delimits the container interior in the transverse direction, and
comprises the rim portion having the first edge;
wherein the first end element
delimits the container interior at a first end of the precursor in the longitudinal direction, and
comprises the further edge;
wherein the rim portion is arranged at the first end of the precursor;
wherein the first edge and the further edge point in the longitudinal direction;
wherein the further edge forms a closed curve with a third length;
wherein the first end element has a height extending in the longitudinal direction at each point of the closed curve;
wherein the rim portion protrudes beyond the further edge at each point of the closed curve such that the rim portion extends from the further edge to the first edge by an overhang length;
wherein the overhang length is measured on a side of the rim portion facing away from the first end element;
wherein the overhang length along at least 50% of the third length is 30 to 100% of the height.

10. A method for producing a liquid-tight container, the method comprising as process steps
a. providing a precursor of the liquid-tight container, the precursor comprising a container wall at least partially surrounding a container interior;
wherein a jacket element and a first end element are connected to one another and each form a portion of the container wall;
wherein the jacket element
delimits the container interior in a transverse direction extending from the inside to the outside in relation to the container interior, and
comprises a rim portion having a first edge;
wherein the first end element
delimits the container interior at a first end of the precursor in a longitudinal direction extending along a length of the precursor, and
comprises a further edge;
wherein the rim portion is arranged at the first end of the precursor;
wherein the first edge and the further edge point in the longitudinal direction;
b. forming the rim portion by contacting it with a forming tool, so that the rim portion encloses the further edge counter to the transverse direction from the outside to the inside in such a way that
i. the first edge of the jacket element points opposite to the longitudinal direction, and
ii. the precursor or the liquid-tight container obtained therefrom has at the first end in the transverse direction a layer sequence comprising
A. a first ply of the jacket element,
B. a ply of the first end element, and
C. a further ply of the jacket element;
characterized in that the forming tool carries out an oscillation with a frequency in a range from 15 to 50 kHz during the forming.

11. The method according to claim 10, wherein the oscillation takes place in a direction that forms an angle of less than 30° with the longitudinal direction and counter to this direction.

12. The method according to claim 10, wherein the forming tool is set into oscillation before contacting the rim portion.

13. A use of the liquid-tight container according to claim 1 for storing or transporting a liquid.

14. A use of a sheet-like composite for producing the liquid-tight container according to claim 1;
wherein the jacket element or the first end element or both are at least partially formed from the sheet-like composite.

15. A use
a) of an ultrasonic generator to excite the oscillation, or
b) of an ultrasonic sonotrode as the forming tool,
c) or a) and b)
each in the method according to claim 10.
